(19) United States
(12) Patent Application Publication
(10) Pub. No.: US 2010/0168409 A1
(43) Pub. Date: Jul. 1, 2010

(54) THERMOPLASTIC RESIN FILM AND METHOD FOR PRODUCING SAME

(76) Inventor: Akihide Fujita, Fujinomiya-shi (JP)

Correspondence Address: SUGHRUE MION, PLLC, 2100 PENNSYLVANIA AVENUE, N.W., SUITE 800, WASHINGTON, DC, 20037, US

(21) Appl. No.: 12/160,855

(22) PCT Filed: Jan. 11, 2007
(86) PCT No.: PCT/JP2007/050630

§ 371 Date: Jul. 14, 2008

(30) Foreign Application Priority Data
Jan. 13, 2006 (JP) 2006-006545

(51) Int. Cl. B29C 47/06; C08B 3/00; G02B 5/30

(52) U.S. Cl. 536/58; 264/210.3; 359/485

(57) ABSTRACT

To provide a thermoplastic resin film, and process for producing the same, which can obtain a film having high optical properties in which the occurrence of residual strain and the exhibition of retardation during film forming are suppressed. A film (12) is produced by extruding melted thermoplastic resins in sheet form through a die (24), and sandwiching the sheet between a pair of rollers (26), (28) configured so that at least one of the rollers is an elastic roller (26) made from metal, to cool and solidify the sheet into the film, the thickness Z of a metal tube (44) constituting an outer shell of the elastic roller (26) being in a range of 0.05 mm<z<7.0 mm, wherein the sheet is formed as a laminate sheet having two or more layers by using two or more of the thermoplastic resins A, B, and in the laminate sheet a glass transition temperature Tg (° C.) of the thermoplastic resin B forming an inner layer is 3 to 50° C. less than the glass transition temperature Tg (° C.) of the thermoplastic resin A forming an outer layer.

### TECHNICAL FIELD

The present invention relates to a thermoplastic resin film and method for producing same, and particularly relates to a thermoplastic resin film, and method for producing same, having preferable quality for a liquid crystal display device.

### BACKGROUND ART

Conventionally, it has been attempted to enlarge viewing angles by stretching a cellulose acylate film for exhibiting in-plane retardation (Re) and retardation (Rth) in the thickness direction and using the film as a retardation film in liquid crystal display elements.

Methods of stretching such a cellulose acylate film include a method of stretching a film in a longitudinal (longitudinal) direction (longitudinal stretching), a method of stretching a film transverse (in the width direction) (transverse stretching), and a method of performing longitudinal stretching and transverse stretching simultaneously (simultaneous stretching). Of these, longitudinal stretching has often been employed because of the compactness of the equipment. In longitudinal stretching, a film is generally heated to its glass transition temperature (Tg) or higher on at least two pairs of nip rolls and stretched in the longitudinal direction with setting the carrying rate of the nip roll on the exit side faster than that of the nip roll on the entry side.

Japanese Patent Application Laid-Open No. 2002-311240 describes a method of longitudinal stretching a cellulose ester. In Japanese Patent Application Laid-Open No. 2002-311240, angle irregularities in the slow axis are improved by performing longitudinal stretching in a direction opposite to the film casting direction. Japanese Patent Application Laid-Open No. 2003-315551 describes a method of stretching with nip rolls disposed in a stretching zone at a small span of a length/width ratio (L/W) of 0.3 to 2. In Japanese Patent Application Laid-Open No. 2003-315551, orientation in the thickness direction (Rth) can be improved. The term “length/width ratio” described herein means a value obtained by dividing the distance (L) between the nip rolls used for stretching by the width (W) of a cellulose acylate film to be stretched.

### DISCLOSURE OF THE INVENTION

However, when producing a pre-stretched (unstretched) cellulose acylate film by a melt film forming step, there is the problem that cellulose acylate resins are not easily leveled due to their high melt viscosity. As a consequence, cellulose acylate films formed by a melt film forming step are prone to the occurrence of streaks, and also suffer from the problem that thickness accuracy is poor. Therefore, if a cellulose acylate film formed by a melt film forming step is stretched, a retardation Re and Rth distribution arises, whereby there has been the problem that high optical properties could not be achieved.

The inventor of the present invention has focused on a polishing roller as a technique for eliminating these problems. A polishing roller process cools the resin extruded through a die while sandwiching with a pair of rollers, whereby the occurrence of streaks can be suppressed and thickness accuracy can be improved.

However, in a polishing process, residual strain occurs in the film, which causes the problem that retardation is liable to be exhibited during film forming. In addition, if a film formed by a polishing process is stretched, a large stretching unevenness (stretching distribution) occurs, which becomes a retardation distribution, causing the problem that a high-performance optical film cannot be obtained.

The present invention was created in view of the above-described circumstances, wherein it is an object of the present invention to provide a thermoplastic resin film, and method for producing same, which can suppress streaking, improves thickness accuracy, and suppress the exhibition of retardation during film forming by suppressing the occurrence of residual strain due to a polishing process, to thereby allow a high-performance optical film to be obtained.

To achieve the above-described object, the invention recited in a first aspect of the present invention provides a method for producing a thermoplastic resin film including forming a film by extruding melted thermoplastic resins in sheet form through a die, and cooling and solidifying the sheet into the film by sandwiching the sheet between a pair of rollers configured so that at least one of the rollers is an elastic roller made from metal, the thickness Z of a metal tube constituting an outer shell of the elastic roller being in a range of 0.05 mm<z<7.0 mm, wherein the sheet is formed as a laminate sheet having two or more layers by using two or more of the thermoplastic resins, and in the laminate sheet a glass transition temperature Tg (° C.) of the thermoplastic resin forming an inner layer is 3 to 50° C. less than the glass transition temperature Tg (° C.) of the thermoplastic resin forming an outer layer.

According to the invention of the first aspect, since a polishing roller process is employed, the occurrence of streaks can be prevented, and thickness accuracy can be improved because the resin is solidified by cooling while sandwiched with a pair of rollers configured such that at least one of the rollers is an elastic roller made from metal. When sandwiching the thermoplastic resin by the pair of rollers, because the rollers are configured such that the thickness Z of a metal tube forming the outer shell of the elastic roller satisfies the equation 0.05 mm<Z<7.0 mm, the elastic roller is elastically deformed and has its face in contact with the cooling roller via the sheet-form resin, so that the resin can be evenly compressed into a planar shape by the resilient force of the elastic roller which causes the elastically deformed shape to revert to the original shape. If the resin is cooled while evenly compressing into a planar shape in this manner, a film is formed which is free from residual strain in its interior, whereby the exhibition of retardation can be further suppressed when forming the film. Here, if the metal tube thickness Z forming the outer shell of the elastic roller is not more than 0.05 mm, the above-described resilient force is small, whereby the effects of eliminating residual strain cannot be achieved, and the roller strength is weak. Further; if the metal tube thickness Z is not less than 7.0 mm, elasticity cannot be obtained, whereby the effects of eliminating residual strain cannot be achieved. While there are no problems if the outer tube thickness satisfies the equation 0.05 mm<Z<7.0 mm, more preferred is 1.5 mm<z<5.0 mm.

Thus, by solidifying a sheet-form melt resin extruded through a die by cooling while sandwiching with a pair of rollers configured such that at least one of the rollers is an elastic roller, it is possible to suppress the exhibition of retardation when forming the film. However, in the present invention further improvements are made to suppress the exhibition of retardation. Specifically, by sandwiching a sheet-form melt resin with a pair of rollers, the sandwiched sheet portion rapidly cools and solidifies, thereby losing its cushioning properties. As a result, even though at least one of the pair of rollers is an elastic roller, the sheet portion which has solidified from rapid cooling is subjected to a large surface pressure, which is the cause of the residual strain.

In view of this point, as a measure against residual strain caused by such surface pressure, the present inventor discovered that the occurrence of residual strain in a film can be dramatically suppressed by forming a laminate sheet so as to have two or more layers by using two or more of the thermoplastic resins, and so that in the laminate sheet a glass transition temperature Tg (° C.) of the thermoplastic resin forming an inner layer is 3 to 50° C. less than the glass transition temperature Tg (° C.) of the thermoplastic resin forming the outer layer.

In other words, when the melt resin is solidified by cooling with a pair of rollers, although the outer layer loses its cushioning properties as a result of solidifying by rapid cooling from surface contact with the pair of rollers, the inner layer resin has a low Tg, so that the resin does not solidify, whereby it can maintain its cushioning properties. Since the linear pressure from the pair of rollers is absorbed by the inner layer, this process is effective in suppressing residual strain in the film, whereby the exhibition of retardation can be dramatically suppressed.

If the laminate sheet is formed as a tri-layer structure from two or more of the thermoplastic resins, the two layers in contact with the pair of rollers become the outer layer, and the other layer(s) become the inner layer(s). Further, if the laminate sheet is formed as a bi-layer structure from two kinds of thermoplastic resin, the layer in contact with the elastic roller becomes the outer-layer. If both of the pair of rollers are elastic rollers, the layer in contact with either of the elastic rollers may be the outer layer.

The invention recited in a second aspect of the present invention is such that, in the first aspect, the pair of rollers satisfies both the following equations (1) and (2): when the glass transition temperature Tg (° C.) of the thermoplastic resin forming the outer layer minus the temperature (° C.) of the elastic roller is represented as “X” (° C.), and line speed is represented as “Y” (m/min),

0.0043X²+1.2X+1.1<Y<0.019X²+0.73X+24 (1)

and when the length along which the pair of rollers are in contact with each other via the laminate sheet is represented as “Q” (cm), and the linear pressure sandwiching the laminate sheet by the pair of rollers is represented as “P” (kg/cm).

3 kg/cm²<P/Q<50 kg/cm² (2)

The present inventor discovered that residual strain in the film and sticking of the film to the elastic roller can be eliminated by satisfying the equation 0.0043X²+0.12X+1.1<Y<0.019X²+0.73X+24, wherein “X” (° C.) represents the glass transition temperature Tg (° C.) of the thermoplastic resin minus the temperature (° C.) of the elastic roller, and “Y” (m/min) represents the line speed. Specifically, if the temperature of the elastic roller and the line speed are varied, it was learned from the results of observation made from numerous perspectives of a film, that if Y is not greater than 0.0043X²+0.12X+1.1, the compressing time is too long, whereby residual strain is liable to occurring in the film, and that if the line speed Y is not less than 0.019X²+0.73X+24, the cooling time is too short, whereby the film is not slowly cooled and tends to stick to the elastic roller.

The present inventor also discovered that residual strain in the film can be prevented by satisfying the equation 3 kg/cm²<P/Q<50 kg/cm², wherein “Q” (cm) represents the length along which the pair of rollers are in contact with each other via the laminate sheet, and “P” (kg/cm) represents the linear pressure sandwiching the laminate sheet by the pair of rollers. Here, if P/Q is equal to or less than 3 kg/cm², the compression force compressing the resin in a planar shape is too small, whereby there is no effect on eliminating residual strain, while if P/Q is equal to or greater than 50 kg/cm², the compression force is too large, which causes residual strain in the film, whereby retardation is exhibited.

Thus, according to the second aspect, if the pair of rollers satisfy both equations (1) and (2), the occurrence of residual strain can be further suppressed, and the exhibition of retardation during film forming can be dramatically suppressed, which allows a film having high optical properties to be obtained.

The invention recited in a third aspect of the present invention is such that, in the first or second aspects, the pair of rollers has a roller surface arithmetic average roughness Ra of at least one of the rollers of no greater than 100 nm.

According to the invention of the third aspect, since a resin is solidified from rapid cooling by being sandwiched by a pair of rollers wherein at least one of the rollers has a surface whose arithmetic average roughness Ra is no greater than 100 nm, surface accuracy can be still further improved.

The invention recited in a fourth aspect of the present invention is such that, in any one of the first to third aspects, the laminate sheet is formed by co-extrusion.

According to the invention of the fourth aspect, a laminate sheet can be formed easily, because the sheet is formed by co-extrusion. The laminate sheet may also be formed by laminating a sheet-form thermoplastic resin extruded using a plurality of dies. The invention recited in a fifth aspect of the present invention is such that, in any one of the first to fourth aspects, the laminate sheet has an A/B/A tri-layer structure consisting of a thermoplastic resin A forming the outer layers and a thermoplastic resin B forming the inner layer, and a glass transition temperature Tg (° C.) of the thermoplastic resin B of 3 to 50° C. less than the glass transition temperature Tg (° C.) of the thermoplastic resin A.

The fifth aspect is a case where a laminate sheet is formed with an A/B/A tri-layer structure with two kinds of thermoplastic resin consisting of a thermoplastic resin A forming the outer layers and a thermoplastic resin B forming the inner layer.

The invention recited in a sixth aspect of the present invention is such that, in any one of the first to fourth aspects, the laminate sheet has an A/B/C/B/A five-layer structure consisting of a thermoplastic resin layer A forming the outer layers and thermoplastic resins B and C forming the inner layers, and a glass transition temperature Tg (° C.) of the thermoplastic resins B and C of 3 to 50° C. less than the glass transition temperature Tg (° C.) of the thermoplastic resin A.

The sixth aspect is a case where a laminate sheet is formed with an A/B/C/B/A five-layer structure with three kinds of thermoplastic resin consisting of a thermoplastic resin A forming the outer layers and thermoplastic resins B and C forming the inner layers.

The invention recited in a seventh aspect of the present invention is such that, in any one of the first to fourth aspects, the laminate sheet has an A/B bi-layer structure consisting of a thermoplastic resin A forming the outer layer and a thermoplastic resin B forming the inner layer, and when one of the pair of rollers is an elastic resin, the thermoplastic resin A in contact with the elastic roller serves as the outer layer.

The seventh aspect is a case where a laminate sheet is formed with an A/B bi-layer structure with two kinds of thermoplastic resin consisting of a thermoplastic resin A forming the outer layer and a thermoplastic resin B forming the inner layer. In this case, the layer in contact with the elastic roller becomes the outer layer. Therefore, if both of the pair of rollers are elastic rollers, either of A or B may serve as the outer layer and the other may serve as the inner layer.

The invention recited in an eighth aspect of the present invention is such that, in any one of the first to seventh aspects, zero shear viscosity of the thermoplastic resin when discharged through the die is no greater than 2,000 Pa·sec.

According to the invention of the eighth aspect, because the zero shear viscosity of the thermoplastic resin when discharged through the die is no greater than 2,000 Pa·sec, the occurrence of streaking in the film can be further prevented. If the zero shear viscosity exceeds 2,000 Pa·sec, the melt resin discharged through the die greatly broadens immediately after being discharged and tends to adhere to the end portion of the die. Such adhered resin can become contaminants, whereby streaking is more likely to occur. The zero shear viscosity can be obtained by, for example, measuring shear velocity dependent data of the melt viscosity using a plate cone type melt viscosity measuring device, and extrapolating the melt viscosity at the zero shear velocity from the measured values of regions where there is no shear velocity dependence of the melt viscosity.

The invention recited in a ninth aspect of the present invention is such that, in any one of the first to eighth aspects, the thickness of the thermoplastic resin forming the outer layer is in a range of 10 to 90% of the film total thickness.

If the thickness of the outer layer is less than 10% of the film total thickness, the Tg of the entire sheet is too low, whereby it is more difficult for the sheet to solidify by cooling even if it is inserted into the pair of rollers. On the other hand, if the thickness of the outer layer is more than 90% of the film total thickness, the thickness of the inner layer is too thin. This means that cushioning properties cannot be obtained, whereby there are no effects for absorbing the surface pressure from the pair of rollers. It is noted that while there are no problems if the thickness of the outer layer is in the range of 10 to 90% of the film total layer thickness, more preferred is 20 to 80%, and still more preferred is 30 to 70%.

The invention recited in a tenth aspect of the present invention is such that, in any one of the first to ninth aspects, the width of the thermoplastic resin forming the outer layer is 99% or more of the film total width.

According to the tenth aspect, by setting the width of the outer layer to be 99% or more of the film total width, the inner layer thermoplastic resin having a low Tg can be prevented from sticking to the roller, and nearly the whole width can be used as a product.

The invention recited in an eleventh aspect of the present invention is such that, in any one of the first to tenth aspects, film thickness is 20 to 300 μm, in-plane retardation Re is no greater than 20 nm and thickness direction retardation Rth is no greater than 20 nm.

According to the eleventh aspect, a thermoplastic resin film can be produced which is suitable as an optical film having high thickness accuracy, no streaking and small strain. As a result, a thermoplastic resin film can be obtained having a film thickness of 20 to 300 μm, in-plane retardation Re of no greater than 20 nm and thickness direction retardation Rth of no greater than 20 nm. Re and Rth are preferably no greater than 10 nm.

The invention recited in a twelfth aspect of the present invention is such that, in any one of the first to eleventh aspects, the thermoplastic resin is a cellulose acylate resin.

The present invention is especially effective in the production of a cellulose acylate film having good exhibition of retardation.

The invention recited in a thirteenth aspect of the present invention is such that, in any one of the first to twelfth aspects, the cellulose acylate resin has an average molecular weight of 20,000 to 80,000, which, when “A” represents the degree of substitution of an acyl group and “B” represents the sum of the degree of substitution of an acyl group having 3 to 7 carbon atoms, satisfies 2.0≦A+B≦3.0, 0≦A≦2.0 and 1.2≦A+B<2.9.

A cellulose acylate film which satisfies this degree of substitution has a low melting point, is easily stretched and has excellent moisture-proofing properties, whereby an excellent cellulose acylate film can be obtained as a functional film, such as a phage difference film for a liquid crystal display device.

A fourteenth aspect of the present invention is thermoplastic resin film produced by any one of the production processes recited in the first to thirteenth aspects. A fifteenth aspect of the present invention is an optical compensatory film for a liquid crystal display plate comprising the thermoplastic resin film of the fourteenth aspect as a substrate. A sixteenth aspect of the present invention is a polarizing plate formed using at least one ply of the thermoplastic resin film of the fourteenth aspect as a protective film of a polarizing film.

The thermoplastic resin film produced by the production processes of the first to thirteenth aspects has high optical properties, and is thus suitable as an optical compensatory film for a liquid crystal display plate or a polarizing plate.

According to the present invention, the occurrence of residual strain and the exhibition of retardation can be suppressed during film forming as a result of sandwiching with a pair of rollers configured so that at least one of the rollers is an elastic roller made from metal to cool and solidify the sheet into the film, the glass transition temperature Tg (° C.) of the thermoplastic resin forming an inner layer being 3 to 50° C. less than the glass transition temperature Tg (° C.) of the thermoplastic resin forming an outer layer.

### BRIEF DESCRIPTION OF THE DRAWINGS

FIG. 1 is a structural diagram of the film-making machine employed in the present invention;

FIG. 2 is a schematic diagram illustrating the structure of an extruder;

FIG. 3 is a schematic diagram of the die employed in the present invention;

FIG. 4 is a schematic diagram of the die employed in the present invention;

FIG. 5 is a cross-sectional diagram of the die employed in the present invention;

FIG. 6 is a schematic diagram illustrating the structure of the film-making step section;

FIG. 7 is an explanatory diagram of the example according to the present invention; and

FIG. 8 is an explanatory diagram of the example according to the present invention.

### DESCRIPTION OF SYMBOLS

10 . . . Film-making machine, 12 . . . Cellulose acylate film, 14 . . . Film-making step section, 16 . . . Longitudinal stretching section, 18 . . . Transverse stretching section, 20 . . . Take up section, 22 . . . Extruder, 23 . . . Extruder, 24 . . . Die, 24a . . . Single layer die, 25 . . . Feed block, 26 . . . Roller (elastic roller), 28 . . . Roller (cooling roller), 44 . . . Metal tube, 46 . . . Liquid medium layer, 48 . . . Elastic layer, 50 . . . Metal shaft, 52 . . . Cylinder, 58 . . . Single screw, 60 . . . Feed port, 62 . . . Discharge port, 70, 72, 74 . . . Channels, 76 . . . Merging section, 78 . . . Channel, 80 . . . Manifold, 82 . . . Slit, 84 . . . Discharge port, 85 . . . Resistor, 86, 88, 90 . . . Manifolds, 92 . . . Merging section, 94 . . . Slit, 96 . . . Discharge port, A, B . . . Cellulose acylate resin films, M . . . Lip land length, Q . . . Contact length, S . . . Film total width (width of the inner layer), T . . . Width of the outer layer, Y . . . Line speed, Z . . . Thickness of the metal tube

### BEST MODE FOR CARRYING OUT THE INVENTION

Preferred embodiments of the method for producing a thermoplastic resin film according to the present invention will now be explained with reference to the attached drawings. It is noted that while examples producing a cellulose acylate film are illustrated in the embodiments of the present invention, the present invention is not intended to be limited to these examples. The present invention can also be applied to the production of thermoplastic resin films such as saturated norbornene resin films, polycarbonate resin films and the like.

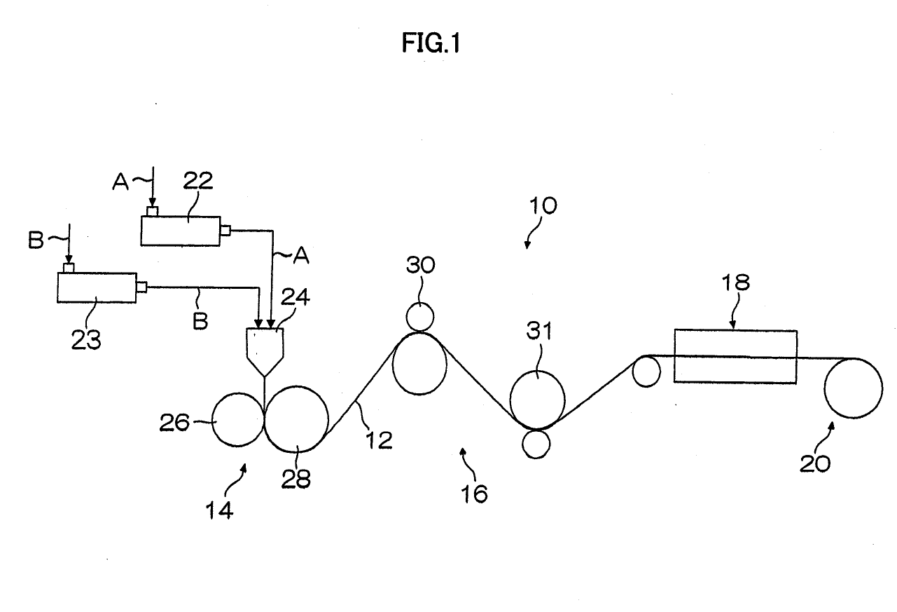

FIG. 1 illustrates one example of the basic structure of the film-making machine for the cellulose acylate resin film according to the present invention when a stretched cellulose acylate resin film is produced by a melt film-forming step.

The film-making machine 10 illustrated in FIG. 1 is mainly configured from a film-making step section 14 which forms a pre-stretched cellulose acylate film 12, a longitudinal stretching section 16 and transverse stretching section 18 which stretch the cellulose acylate film 12 formed by the film-making step section 14 in both a longitudinal and transverse manner, and a pick-up step section 20 which takes up the stretched cellulose acylate film 12.

At the film-making step section 14, cellulose acylate resin films A and B respectively melted by extruders 22 and 23 are extruded in sheet form through a die 24, and are fed into the space between a pair of rotating rollers 26, 28. The cellulose acylate film 12 which has solidified from cooling on the roller (cooling roller) 28 is peeled off the cooling roller 28, and is then stretched by feeding in turn through the longitudinal stretching section 16 and the transverse stretching section 18. The resultant film is then taken up in a roll shape by the pick-up step section 20 to thereby produce a stretched cellulose acylate film 12.

Here, the cellulose acylate resin B has a glass transition temperature Tg 3 to 50° C. lower than that of the cellulose acylate resin A.

The details of each of the step sections will now be described.

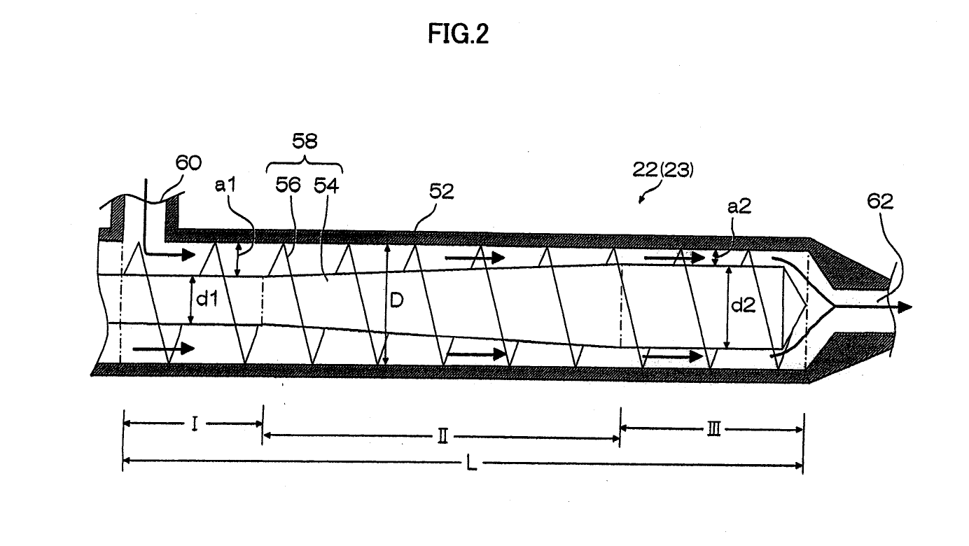

FIG. 2 illustrates the configuration of the extruder 22 (23) in the film-making step section 14. As illustrated in FIG. 2, a single screw 58 equipped with a flight 56 on the screw shaft 54 is provided in a cylinder 52 of the extruder 22 (23). The single screw 58 is rotated by a motor (not shown).

A hopper (not shown) is attached to a feed port 60 of the cylinder 52. Cellulose acylate resin A (B) is fed from this hopper into the cylinder 52 via the feed port 60.

The cylinder 52 interior comprises, in order from the feed port 60, a feed section which conveys a fixed amount of cellulose acylate resin fed from the feed port 60 (region indicated by I), a compression section which kneads and compresses the cellulose acylate resin (region indicated by II), and a metering section which weighs the kneaded and comprised cellulose acylate resin (region indicated by III). The cellulose acylate resin melted by the extruder 22 (23) is continuously fed from a discharge port 62 to the die 24.

The screw compression ratio of the extruder 22 (23) is set at 2.5 to 4.5, and L/D is set between 20 and 70. Here, “screw compression ratio” refers to the volume ratio of the feed section I to the metering section III, and is represented by: (volume per unit length of the feed section I)/(volume per unit length of the metering section III). This calculation uses the outer diameter d1 of the feed section I screw shaft 34, the outer diameter d2 of the metering section III screw shaft 34, the groove diameter a1 of the feed section I, and the groove diameter a2 of the metering section 111. The term “L/D” refers to the ratio of the cylinder diameter (D) in FIG. 2 to the cylinder length (L). The extrusion temperature is set at 190 to 240° C. In cases where the temperature in the extruder 22 (23) exceeds 240° C., a cooler (not shown) may be provided between the extruder 22 (23) and the die 24.

While the extruder 22 (23) may be either a single-screw extruder or a twin-screw extruder, if the screw compression ratio is too small (below 2.5), the kneading cannot be carried out sufficiently, whereby unmelted portions can occur. As a result, shearing heat generation is small and melting of the crystals is insufficient, whereby fine crystals are more likely to remain in the cellulose acylate film after production and air bubbles are more likely to be mixed therein. As a consequence, when the cellulose acylate film 12 is stretched, the residual crystals inhibit the stretching performance, thereby rendering it impossible for the orientation to be sufficiently increased. On the other hand, if the screw compression ratio is too large (exceeding 4.5), the resin is more susceptible to degradation from heat due to too great a shearing stress being applied, whereby yellowing tends to appear in the produced cellulose acylate film. In addition, if too great a shearing stress is applied, the molecules can shear, whereby the molecular weight is reduced and the mechanical strength of the film is decreased. Therefore, to make it less likely for yellowing to appear on the film and less likely for stretching fractures to occur, the screw compression ratio is preferably in the range of 2.5 to 4.5, more preferably 2.8 to 4.2, and especially preferably 3.0 to 4.0.

If L/D is too small (below 20), the melting or kneading is insufficient, so that as is the case with when the compression ratio is too small, fine crystals are more likely to remain in the cellulose acylate film after production. On the other hand, if L/D is too large (exceeding 70), the residence time of the cellulose acylate resin in the extruder 22 (23) is too long, whereby the resin is more susceptible to being degraded. In addition, if the residence time is longer, breaking of the molecules occurs, whereby the molecular weight is reduced and the mechanical strength of the film is decreased. Therefore, to make it less likely for yellowing to appear on the film and less likely for stretching fractures to occur, L/D is preferably in the range of 20 to 70, more preferably 22 to 45, and especially preferably 24 to 40.

If the extrusion temperature is too small (below 190° C.), the melting of the crystals is insufficient, whereby fine crystals are more likely to remain in the cellulose acylate film after production, so that when the cellulose acylate film is stretched, the stretching performance is inhibited, thereby rendering it impossible for the orientation to be sufficiently increased. On the other hand, if the extrusion temperature is too high (exceeding 240° C.), the cellulose acylate resin is degraded, and the yellowing (YI value) level worsens. Therefore, to make it less likely for yellowing to appear on the film and less likely for stretching fractures to occur, the extrusion temperature is preferably in the range of 190 to 240° C., more preferably 195 to 235° C., and especially preferably 200 to 230° C.

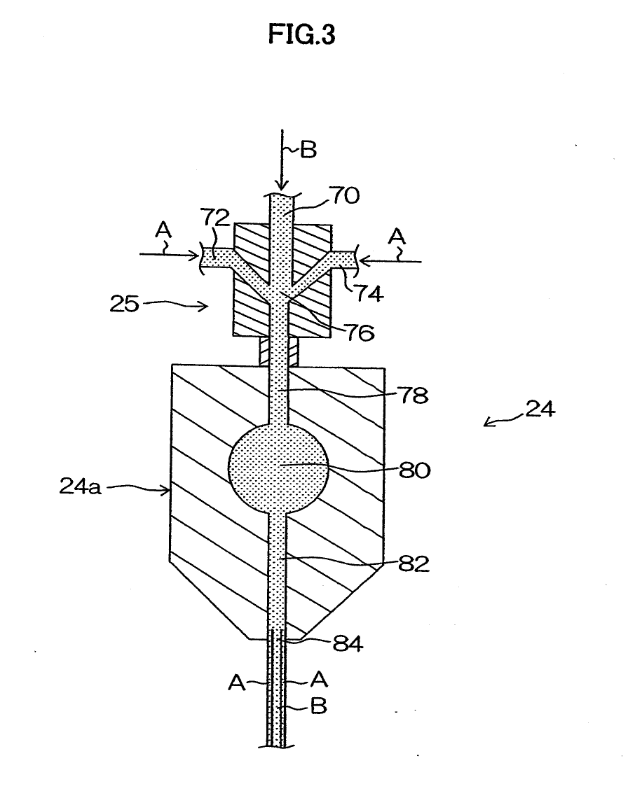

The two kinds of melted cellulose acylate resin A and B are continuously fed to the die 24 (refer to FIG. 1). The die 24 illustrated in FIG. 3 is configured from a feed block 25 for merging the two kinds of melted cellulose acylate resin A and B into a tri-layer sheet, and a single layer die 24a for broadening the merged resins A and B.

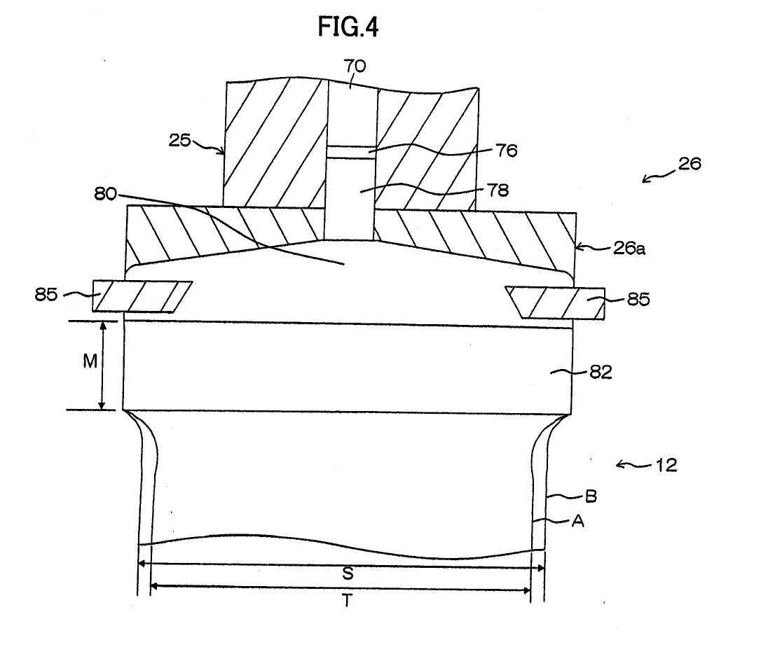

The melted cellulose acylate resin B is fed from the extruder 22 to a channel 70 of the feed block 25, and the melted cellulose acylate resin A is fed from the extruder 23 to channels 72 and 74 of the feed block 25. The channels 70, 72 and 74 merge at the merging section 76. The melted cellulose acylate resins A and B merge at the merging section 76, then flow along a channel 78 to be fed to the single layer die 24a. The melted cellulose acylate resins A and B are broadened at a manifold 80 of the single layer die 24a, and then discharged onto the cooling roller 28 from a discharge port 84 through slit 82. As illustrated in FIG. 4, if the distance from the manifold 80 of the die 24 to the discharge port 84 (lip land length) M is in the range of 5 mm or more to 150 mm or less, there are smoothing effects, whereby the surface roughness of the cellulose acylate film 12 can be lowered. While there are no problems if the lip land length M is 5 mm or more to 150 mm or less, more preferred is 10 min or more to 120 mm or less, and still more preferred is 30 mm or more to 100 mm or less.

FIG. 4 is a cross-sectional diagram of the die 24 of FIG. 3 viewed in the width direction, wherein the melt resin flows through the channels 70, 78 and the slit 82 and is then discharged in sheet form.

Although the melt resin is discharged in sheet form through the end (bottom end) of the die 24, as illustrated in FIG. 4, it is preferable to broaden the melted cellulose acylate resin A in a width direction by adjusting the width of the single layer die 24a manifold 80 with movable resistors 85, 85 provided at both ends of the manifold 80. Typically, the manifold 80 ends cause material to accumulate, so that when extruding from both ends the resin which will form the outer layer is subjected to flow resistance, causing the width T of the outer layer to be narrower than the width S of the inner layer. By suitably positioning the movable resistors 85, 85 provided at both ends of the manifold 80, the resin flow can be altered, thereby allowing the outer layer cellulose acylate resin to be broadened in the width direction. Especially if the width T of the outer layer is 99% or more of the film total width (inner layer width) S, the inner layer cellulose acylate resin B having a low Tg can be prevented from sticking on the roller 26, 28, and nearly the whole width can be used as a product.

The thickness of the outer layer cellulose acylate resin B is set in the range of 10 to 90% of the film total layer thickness. By setting in this range, the channels 72 and 74 can be made narrower. Since the thickness of the outer layer cellulose acylate resin B is set in the range of 10 to 90% of the film total layer thickness, the compressing force of the below-described rollers 26, 28 can be sufficiently received at the liquid-state inner layer, thereby allowing residual strain to be suppressed. As a consequence, it is possible to provide a cellulose acylate film 12 which can be preferably used as a high-performance film for optical applications. If the thickness of the outer layer is less than 10% of the film total thickness, the Tg of the entire sheet is too low, whereby the sheet does not solidify by cooling even if it is inserted into the rollers. On the other hand, if the thickness of the outer layer is more than 90% of the film total thickness, the thickness of the inner layer is too thin. This means that cushioning properties cannot be obtained, whereby there are no effects for absorbing the surface pressure from the pair of rollers. It is noted that while there are no problems if the thickness of the outer layer is in the range of 10 to 90% of the film total layer thickness, more preferred is 20 to 80%, and still more preferred is 30 to 70%.

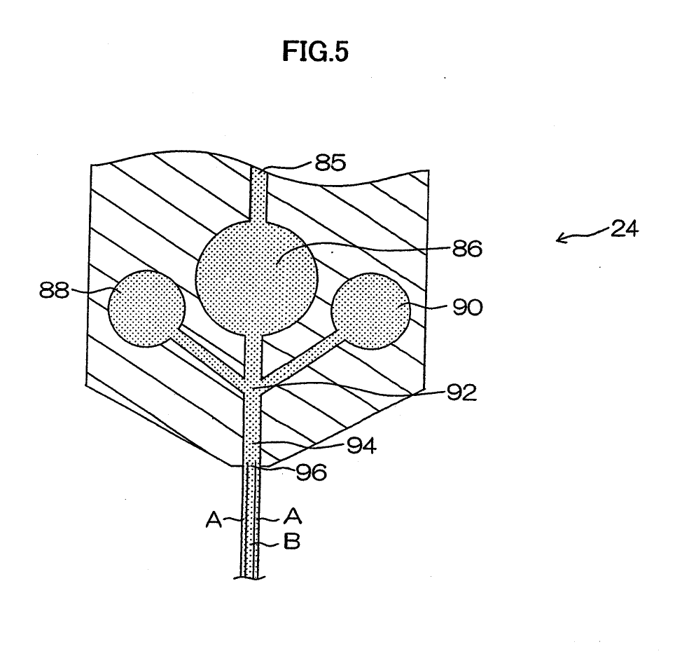

FIG. 5 is a schematic view of a multi-manifold type die 24 according to a separate embodiment which has a plurality of manifolds 86, 88, 90 (in FIG. 5, these are located at three positions). Cellulose acylate resin B is fed to the manifold 86 from an extruder 23 via a channel 85, and cellulose acylate resin A is fed to the manifolds 88, 90 from an extruder 22 via a channel (not shown). The cellulose acylate resins A and B are merged at a merging section 92, then discharged onto a cooling roller 28 from a discharge port 96 through slit 94. Thus, because the die 24 is a multi-manifold type, the thicknesses of the outer layer and the inner layer can both be uniformly maintained, and the two kinds of melted cellulose acylate resins can be prevented from wrapping around each other. In addition, while not shown in the drawings, by providing movable resistors at suitable locations as with the feed block type die of FIG. 3, the outer layer cellulose acylate resin can be broadened in the width direction.

The cellulose acylate resins A, B are melted by the extruder 22 (23) configured in the above-described manner. The melted resins are continuously fed to a die 24, and then extruded in an A/B/A tri-layer sheet form through the end (bottom end) of the die 24. At this point, the zero shear viscosity of the discharged cellulose acylate resins A, B is preferably no greater than 2,000 Pa·sec. If the zero shear viscosity of the discharged cellulose acylate resins A, B exceeds 2,000 Pa·sec, the melt resin discharged through the die greatly broadens immediately after being discharged and thus tends to adhere to the end portion of the die. Such adhered resin can become contaminants, whereby streaking is more likely to occur. The discharged melt resin is fed in between the pair of rollers 26, 28 (refer to FIG. 1).

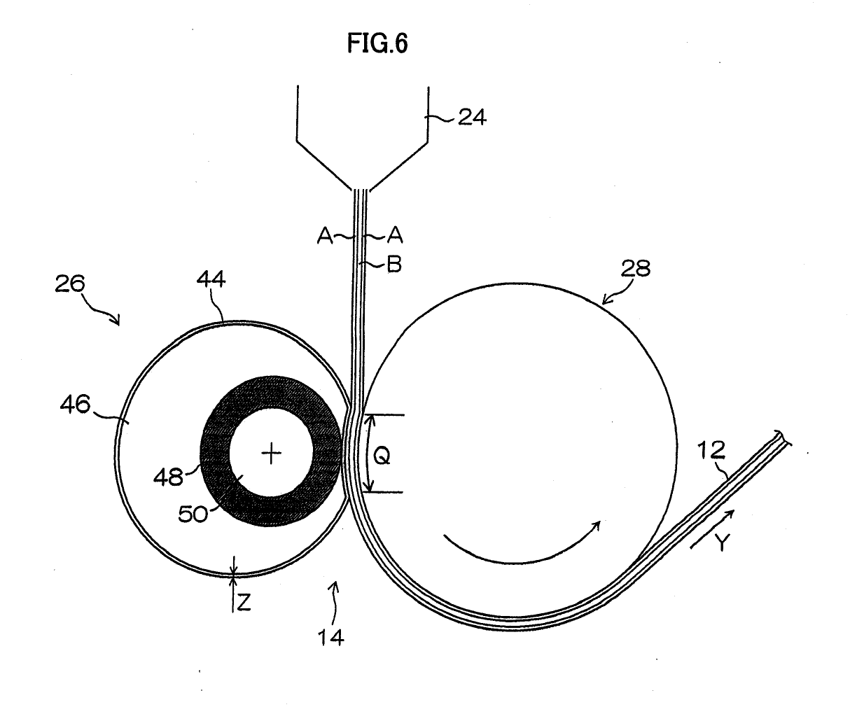

FIG. 6 illustrates an embodiment of a pair of rollers 26, 28. The pair of rollers 26, 28 are configured such that one roller is an elastic roller 26 made from metal, while the other roller is a cooling roller 28. While both of the rollers may be elastic, in the present embodiment they will be explained with one being an elastic roller.

The surface of each of the rollers 26, 28 is a mirror surface or close to a mirror surface, and is mirror finished so that its arithmetic average roughness Ra is no greater than 100 nm, preferably no greater than 50 nm, and more preferably no greater than 25 nm. In this case, at least one of the pair of rollers must have an Ra of no greater than 100 nm. Further, the rollers 26, 28 are configured so that their surface temperature can be controlled. The surface temperature can be controlled by, for example, circulating a liquid medium such as water inside the rollers 26, 28. In addition, the rollers 26, 28 are connected to a rotation drive device, such as a motor, so that they can rotate at approximately the same speed as the speed at the point where the melt resin extruded through the die 24 lands.

Of the pair of rollers 26, 28, the roller (elastic roller) 26 has a smaller diameter than the other roller (cooling roller) 28, and has a surface made from a metal material, whereby its surface temperature can be accurately controlled. The elastic roller 26 is configured from, in order, a metal tube 44 which forms an outer shell from the outer layer, a liquid medium layer 46, an elastic layer 48, and a metal shaft 50. With such a structure, if the sheet-form melt resin is sandwiched by the pair of rollers 26, 28, the elastic roller 26 receives the stress from the cooling roller 28 via the sheet, and elastically deforms in a concave shape in accordance with the surface of the cooling roller 28. Therefore, the elastic roller 26 and the cooling roller 28 are in contact with the surface of the sheet, and the sandwiched sheet is cooled by the cooling roller 28 while being compressed in a planar shape by the resilient force of the elastically deformed elastic roller 26 to revert to its original shape. The outer shell 44 is made from a metal thin film, and preferably has a seamless structure with no weld seams.

Here, as the inner layer a cellulose acylate resin B is used which has a Tg 3 to 50° C. lower than that of the outer layer cellulose acylate resin A. Thus, when the resins are solidified by cooling with the rollers 26, 28, although the outer layer cellulose acylate resin A is solidified as a result of rapid cooling by bringing the resin into surface contact with the rollers 26, 28, the inner layer cellulose acylate resin B is not solidified due to its low Tg. The inner layer cellulose acylate resin B is thus in a soft liquid state, whereby the compression force applied from the rollers 26, 28 to compress into a planar shape can be received by the inner layer cellulose acylate resin B rather than the solidified outer layer cellulose acylate resin A. As a result, residual strain in the film can be suppressed.

The thickness Z of the metal tube 44 forming the outer shell of the elastic roller is in the range of 0.05 mm<z<7.0 mm. If the metal tube thickness Z of the elastic roller 26 is not more than 0.05 mm, the above-described resilient force is small, whereby the effects of eliminating residual strain cannot be achieved, and the roller strength is weak.

If the metal tube thickness Z is not less than 7.0 mm, elasticity cannot be obtained, whereby the effects of eliminating residual strain cannot be achieved. While there are no problems if the metal tube thickness satisfies the equation 0.05 mm<z<7.0 mm, more preferred is 1.5 mm<Z<5.0 mm.

If the glass transition temperature Tg of the outer layer cellulose acylate resin A (° C.) minus the temperature (° C.) of the elastic roller 26 is represented as “X” (° C.), and the line speed is represented as “Y” (m/min), the line speed Y and the roller (elastic roller) 26 temperature are set so as to satisfy 0.0043X²+0.12X+1.1<Y<0.019X²+0.73X+24. If the line speed Y is not greater than 0.0043X²+0.12X+1.1, the compressing time is too long, thereby causing residual strain in the film. If the line speed Y is not less than 0.019X²+0.73X+24, the cooling time is too short, whereby the film is not slowly cooled and sticks to the elastic roller 26. For example, if the cellulose acylate resin Tg is 120° C., when the elastic roller 26 temperature is 115° C., 90° C. and 60° C., residual strain appears in the film when the line speed Y is respectively equal to or less than 1 m/min, 8 m/min and 23 m/min, and sticking onto the elastic roller occurs when the line speed Y is respectively equal to or greater than 29 m/min, 64 m/min and 137 m/min. Moreover, experiments were conducted with various resins to determine the relational expression between X and Y based on the obtained experimental data. In addition, it is preferable that the cooling roller 28 temperature is within ±20° C. of the elastic roller 26 temperature.

Further, if the length along which the elastic roller 26 and the cooling roller 28 of the pair of rollers 26, 28 are in contact with each other is represented as “Q” (cm), and the linear pressure sandwiching the sheet-form cellulose acylate resins A, B by the elastic roller 26 and the cooling roller 28 is represented as “P” (kg/cm), then the linear pressure P and the contact length Q are set so as to satisfy the equation 3 kg/cm²<P/Q<50 kg/cm². Here, if P/Q is equal to or less than 3 kg/cm², the compression force compressing the resin in a planar shape is too small, whereby there is no effect on eliminating residual strain, while if P/Q is equal to or greater than 50 kg/cm², the compression force is too large, which causes residual strain in the film, whereby retardation is exhibited.

According to the film-making step section 14 configured in the above-described manner; by discharging the cellulose acylate resin through the die 24, the cellulose acylate resin is turned into a sheet form having a thickness adjusted by pressing between the pair of rollers 26, 28 wherein the discharged cellulose acylate resin forms a very slight bank between the pair of rollers 26, 28. At this point, the elastic roller 26 receives a reaction force from the cooling roller 28 via the cellulose acylate resin, and elastically deforms in a concave shape in accordance with the surface of the cooling roller 28. The cellulose acylate resin is compressed in a planar shape by the elastic roller 26 and the cooling roller 28. By using as the inner layer a cellulose acylate resin B which has a Tg 3 to 50° C. lower than that of the outer layer cellulose acylate resin A, the compression force can be received by the liquid-state cellulose acylate resin B rather than the outer layer cellulose acylate resin A which has been solidified by cooling, thus allowing residual strain in the film to be suppressed. Further, if the film 12 is produced by pressing between rollers 26, 28 which satisfy the above-described roller surface arithmetic average roughness Ra, temperature, linear pressure and cooling length, a cellulose acylate film 12 suitable as an optical film can be produced having no streaking, high thickness accuracy, suppressed residual strain and small retardation. Moreover, according to the film-making step section 14 configured in the above-described manner, a cellulose acylate film 12 can be produced having a film thickness of 20 to 300 μm and an in-plane retardation Re and thickness direction retardation Rth of no greater than 20 nm, and more preferably no greater than 10 nm.

Here, retardation Re, Rth can be determined by the following equations.

Re(nm)=|n(MD)−n(TD)|×T(nm)

Rth(nm)=|{(n(MD)+n(TD))/2}−n(TH)|×T(nm)

In the equations, n(MD), n(TD) and n(TH) designate the refractive index of the longitudinal direction, width direction and thickness direction, and T designates thickness denoted in nm units.

The film 12 pressed by the pair of rollers 26, 28 is taken up onto the cooling roller 28 and cooled, then pulled away from the surface of the cooling roller 28 and moved onto a subsequent longitudinal stretching section 16.

The stretching step in which the cellulose acylate film 12 formed in the film forming section 14 undergoes stretching and is formed into a stretched cellulose acylate film 12 will be described below.

Stretching of the cellulose acylate film 12 is performed so as to orient the molecules in the cellulose acylate film 12 and develop the in-plane retardation (Re) and the retardation across the thickness (Rth) in the film.

As shown in FIG. 1, the cellulose acylate film 12 is first stretched in the longitudinal direction in the longitudinal stretching section 16. In the longitudinal stretching section 16, the cellulose acylate film 12 is preheated and the cellulose acylate film 12 in the heated state wound around the two nip rolls 30, 32. The nip roll 32 on the outlet side conveys the cellulose acylate film 12 at higher conveying speeds than the nip roll 30 on the inlet side, whereby the cellulose acylate film 12 is stretched in the longitudinal direction.

The cellulose acylate film 12 having been stretched longitudinally is fed to the transverse stretching section 18 where it is stretched across the width. In the transverse stretching section 18, a tenter is suitably used. The tenter stretches the cellulose acylate film 12 in the transverse direction while fastening both side ends of the film 12 with clips. This transverse stretching can further increase the retardation Rth.

By subjecting to the above-described longitudinal and transverse stretching processes, a stretched cellulose acylate film 12 can be obtained which exhibits retardation Re, Rth. The stretched cellulose acylate film 12 preferably has an Re of 0 nm to 500 nm or less, more preferably 10 or more to 400 nm or less, and even more preferably 15 or more to 300 nm or less; and an Rth of preferably 0 to 500 nm or less, more preferably 50 or more to 400 nm or less, and even more preferably 70 or more to 350 nm or less. Of the stretched cellulose acylate films described above, those satisfy the formula, Re≦Rth, are more preferable and those satisfy the formula, Re×2.5 Rth, are much more preferable. To realize such a high Rth and a low Re, it is preferable to stretch the cellulose acylate film having been stretched longitudinally in the transverse direction (across the width). Specifically, in-plane retardation (Re) represents the difference between the orientation in the longitudinal direction and the orientation in the transverse direction, and if the stretching is performed not only in the longitudinal direction, but in the transverse direction—the direction perpendicular to the longitudinal direction, the difference between the orientation in the longitudinal direction and the orientation in the transverse direction can be decreased, and hence the in-plane retardation (Re). And at the same time, stretching in both the longitudinal and transverse directions increases the area magnification, and therefore, the orientation across the thickness increases with decrease in the thickness, which in turn increases Rth.

Further, fluctuations in Re and Rth in the transverse direction and the longitudinal direction depending on locations are kept preferably 5% or less, more preferably 4% or less and much more preferably 3% or less. Further, the orientation angle is preferably 90°±5° or less or 0°±5° or less, more preferably is 90°±3° or less or 0°±3° or less, and even more preferably is 90°±1° or less or 0°±1° or less. Such limited ranges can be attained by a reduction in bowing by a stretching process as in the present invention. Such bowing distortion is no greater than 10%, preferably no greater than 5% and more preferably no greater than 3%, where the distortion is determined by first drawing a straight cross line across the surface of the cellulose acylate film, then feeding the film into the tenter to stretch it, and dividing a deviation of the film center by the film width which center is concavely deformed as a result of the stretching.

While the present embodiment was described with respect to a cellulose acylate film requiring a stretching step, the present invention is similarly applicable to a unstretched cellulose acylate film that does not require a stretching step.

Further, while a tri-layer cellulose acylate film was described above which consisted of two kinds of cellulose acylate resin that were co-extruded through a die onto a cooling support body, the resultant resin being extruded in sheet form to solidify by cooling, the present invention is similarly applicable to a cellulose acylate film having two or more layers wherein two or more kinds of cellulose acylate resin may be co-extruded through the die onto the cooling substrate, the resultant resin being extruded in sheet form to solidify by cooling.

A synthesis method of cellulose acylate and production method of cellulose acylate film suitable for the present invention will now be explained in detail in accordance with the procedures thereof.

### (1) Plasticizer

To a resin for use in producing a cellulose acylate film according to the present invention, preferably a polyol plasticizer is added. Such a plasticizer has effects of not only lowering the modulus of elasticity of the resin, but also decreasing the difference in crystal amount between both sides of the film. The content of a polyol plasticizer in the cellulose acylate resin is preferably 2 to 20% by mass. The polyol plasticizer content is preferably 2 to 20% by mass, more preferably 3 to 18% by mass, and much more preferably 4 to 15% by mass. If the polyol plasticizer content is less than 2% by mass, the above described effects cannot be fully attained, while if the polyol plasticizer content is more than 20% by mass, bleeding (migration of the plasticizer to the film surface) occurs. Polyol plasticizers practically used in the present invention include: for example, glycerin-based ester compounds such as glycerin ester and diglycerin ester; polyalkylene glycols such as polyethylene glycol and polypropylene glycol; and compounds in which an acyl group is bound to the hydroxyl group of polyalkylene glycol, all of which are highly compatible with cellulose fatty acid ester and produce remarkable thermoplasticization effect.

Specific examples of glycerin esters include: not limited to, glycerin diacetate stearate, glycerin diacetate palmitate, glycerin diacetate mystirate, glycerin diacetate laurate, glycerin diacetate caprate, glycerin diacetate nonanate, glycerin diacetate octanoate, glycerin diacetate heptanoate, glycerin diacetate hexanoate, glycerin diacetate pentanoate, glycerin diacetate oleate, glycerin acetate dicaprate, glycerin acetate dinonanate, glycerin acetate dioctanoate, glycerin acetate diheptanoate, glycerin acetate dicaproate, glycerin acetate divalerate, glycerin acetate dibutyrate, glycerin dipropionate caprate, glycerin dipropionate laurate, glycerin dipropionate mystirate, glycerin dipropionate palmitate, glycerin dipropionate stearate, glycerin dipropionate oleate, glycerin tributyrate, glycerin tripentanoate, glycerin monopalmitate, glycerin monostearate, glycerin distearate, glycerin propionate laurate, and glycerin oleate propionate. Either any one of these glycerin esters alone or two or more of them in combination may be used.

Of these examples, preferable are glycerin diacetate caprylate, glycerin diacetate pelargonate, glycerin diacetate caprate, glycerin diacetate laurate, glycerin diacetate myristate, glycerin diacetate palmitate, glycerin diacetate stearate, and glycerin diacetate oleate.

Specific examples of diglycerin esters include: not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaprate, diglycerin tetralaurate, diglycerin tetramystyrate, diglycerin tetramyristylate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caprate, diglycerin triacetate laurate, diglycerin triacetate mystyrate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaprate, diglycerin diacetate dilaurate, diglycerin diacetate dimystyrate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaprate, diglycerin acetate trilaurate, diglycerin acetate trimystyrate, diglycerin acetate trimyristylate, diglycerin acetate tripalmitate, diglycerin acetate tristearate, diglycerin acetate trioleate, diglycerin laurate, diglycerin stearate, diglycerin caprylate, diglycerin myristate, and diglycerin oleate. Either any one of these diglycerin esters alone or two or more of them in combination may be used.

Of these examples, diglycerin tetraacetate, diglycerin tetrapropionate, diglycerin tetrabutyrate, diglycerin tetracaprylate and diglycerin tetralaurate are preferably used.

Specific examples of polyalkylene glycols include: not limited to, polyethylene glycols and polypropylene glycols having an average molecular weight of 200 to 1000. Either any one of these examples or two of more of them in combination may be used.

Specific examples of compounds in which an acyl group is bound to the hydroxyl group of polyalkylene glycol include: not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanate, polyoxyethylene caprate, polyoxyethylene laurate, polyoxyethylene myristylate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanate, polyoxypropylene caprate, polyoxypropylene laurate, polyoxypropylene myristylate, polyoxypropylene palmitate, polyoxypropylene stearate, polyoxypropylene oleate, and polyoxypropylene linoleate. Either any one of these examples or two or more of them in combination may be used.

To allow these polyols to fully exert the above described effects, it is preferable to perform the melt film forming of cellulose acylate under the following conditions. Specifically, in the film formation process where pellets of the mixture of cellulose acylate and polyol are melt in an extruder and extruded through a T-die, it is preferable to set the temperature of the extruder outlet (T2) higher than that of the extruder inlet (T1), and it is more preferable to set the temperature of the die (T3) higher than T2. In other words, it is preferable to increase the temperature with the progress of melting. The reason for this is that if the temperature of the above mixture is rapidly increased at the inlet, polyol is first melt and liquefied, and cellulose acylate is brought to such a state that it floats on the liquefied polyol and cannot receive sufficient shear force from the screw, which results in occurrence of un-molten cellulose acylate. In such an insufficiently mixed mixture of polyol and cellulose acylate, polyol, as a plasticizer, cannot exert the above described effects; as a result, the occurrence of the difference between both sides of the melt film after melt extrusion cannot be effectively suppressed. Furthermore, such inadequately molten matter results in a fish-eye-like contaminant after the film formation. Such a contaminant is not observed as a brilliant point even through a polarizer, but it is visible on a screen when light is projected into the film from its back side. Fish eyes may cause tailing at the outlet of the die, which results in increased number of die lines.

T1 is preferably in the range of 150 to 200° C., more preferably in the range of 160 to 195° C., and more preferably in the range of 165 to 190° C. T2 is preferably in the range of 190 to 240° C., more preferably in the range of 200 to 230° C., and more preferably in the range of 200 to 225° C. It is most important that such melt temperatures T1, T2 are 240° C. or lower. If the temperatures are higher than 240° C., the modulus of elasticity of the formed film tends to be high. The reason is probably that cellulose acylate undergoes decomposition because it is melted at high temperatures, which causes crosslinking in it, and hence increase in modulus of elasticity of the formed film. The die temperature T3 is preferably 200 to less than 235° C., more preferably in the range of 205 to 230° C., and much more preferably in the range of 205 to 225° C.

### (2) Stabilizer

In the present invention, it is preferable to use, as a stabilizer, either phosphite compound or phosphite ester compound, or both phosphite compound and phosphite ester compound. This enables not only the suppression of film deterioration with time, but the improvement of die lines. These compounds function as a leveling agent and get rid of the die lines formed due to the irregularities of the die.

The amount of these stabilizers mixed is preferably 0.005 to 0.5% by mass, more preferably 0.01 to 0.4% by mass, and much more preferably 0.02 to 0.3% by mass of the resin mixture.

(i) Phosphite stabilizer

Specific examples of preferred phosphite color protective agents include: not limited to, phosphite color protective agents expressed by the following chemical formulas (general formulas) (1) to (3).

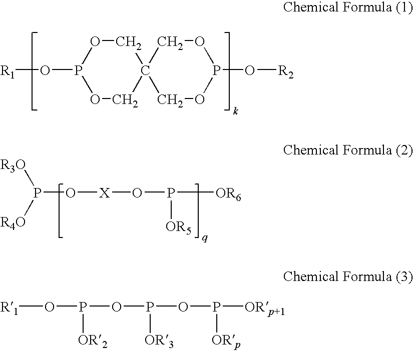

(In the above chemical formulas, R1, R2, R3, R4, R5, R6, R′1, R′2, R′3, R′n, . . . R′n+1 each represent hydrogen or a group selected from the group consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl which have 4 or more and 23 or less carbon atoms. However, in the chemical formulas (1), (2) and (3), at least one substituent is not hydrogen; and the functional group RX in the respective formulae are not simultaneously hydrogen and may be any of the above-described functional groups (e.g., an alkyl group)).

X in the phosphite color protective agents expressed by the chemical formula (2) represents a group selected from the group consisting of aliphatic chain, aliphatic chain with an aromatic nucleus on its side chain, aliphatic chain including an aromatic nucleus in it, and the above described chains including two or more oxygen atoms not adjacent to each other. k and q independently represents an integer of 1 or larger, and p an integer of 3 or larger.)

The k, q in the phosphite color protective agents are preferably 1 to 10. If the k, q are 1 or larger, the agents are less likely to volatilize when heating. If they are 10 or smaller, the agents have an improved compatibility with cellulose acetate propionate.

Thus the k, q in the above range are preferable. p is preferably 3 to 10. If the p is 3 or more, the agents are less likely to volatilize when heating. If the p is 10 or less, the agents have improved compatibility with cellulose acetate propionate.

Specific examples of preferred phosphite color protective agents expressed by the chemical formula (general formula) (1) below include phosphite color protective agents expressed by the chemical formulas (4) to (7) below.

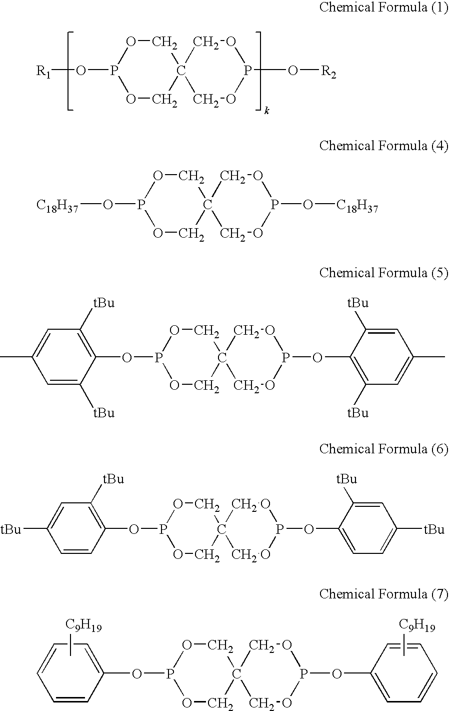

Specific examples of preferred phosphite color protective agents expressed by the chemical formula (general formula) (2) below include phosphite color protective agents expressed by the chemical formulas (8), (9) and (10) below.

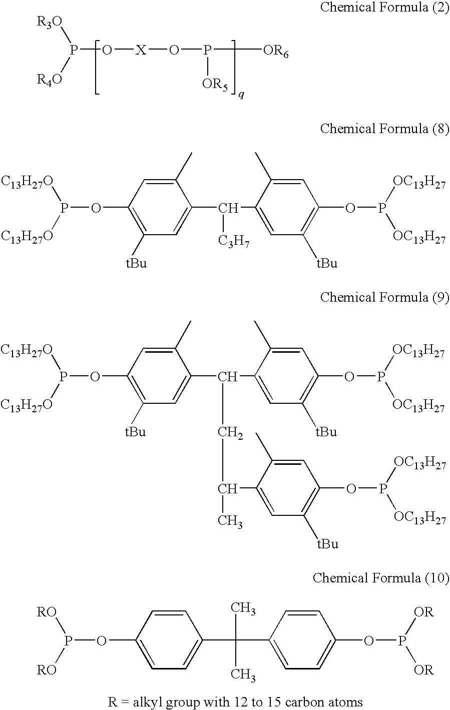

### (ii) Phosphite Ester Stabilizer

Examples of phosphite ester stabilizers include: cyclic neopentane tetraylbis(octadecyl)phosohite, cyclic neopentane tetraylbis(2,4-di-t-butylphenyl)phosohite, cyclic neopentane tetraylbis(2,6-di-t-butyl-4-methylphenyl)phosohite, 2,2-methylene-bis(4,6-di-t-butylphenyl)octylphosphite, and tris(2,4-di-t-butylphenyl)phosphite.

(iii) Other Stabilizers

A weak organic acid, thioether compound, or epoxy compound, as a stabilizer, may be mixed with the resin mixture. Any weak organic acids can be used as a stabilizer in the present invention, as long as they have a pKa of 1 or more, do not interfere with the action of the present invention, and have color preventive and deterioration preventive properties. Examples of such weak organic acids include: tartaric acid, citric acid, malic acid, fumaric acid, oxalic acid, succinic acid and maleic acid. Either any one of these acids alone or two or more of them in combination may be used.

Examples of thioether compounds include: dilauryl thiodipropionate, ditridecyl thiodipropionate, dimyristyl thiodipropionate, distearyl thiodipropionate, and palmityl stearyl thiodipropionate. Either any one of these compounds alone or two or more of them in combination may be used.

Examples of epoxy compounds include: compounds derived from epichlorohydrin and bisphenol A. Derivatives from epichlorohydrin and glycerin or cyclic compounds such as vinyl cyclohexene dioxide or 3,4-epoxy-6-methylcyclohexylmethyl-3,4-epoxy-6-methylcyclohexane carboxylate can also be used. Epoxydized soybean oil, epoxydized castor oil or long-chain α-olefin oxides can also be used. Either any one of these compounds alone or two or more of them in combination may be used.

### (3) Cellulose Acylate

### <<Cellulose Acylate Resin>>

### (Composition, Degree of Substitution)

A cellulose acylate that satisfies all of the requirements expressed by the following formulas (1) to (3) is preferably used in the present invention.

2.0≦A+B≦3.0 formula (1)

0≦A≦2.0 formula (2)

1.0≦B≦2.9 formula (3)

(in the equations 1 to 3, A represents the degree of substitution by an acetate group and B represents the total degree of substitution by a propionate group, a butyrate group, a pentanoyl group and a hexanoyl group)

Preferably,

2.0≦A+B≦3.0 formula (4)

0≦A≦2.0 formula (5)

1.2≦B≦2.9 formula (6)

More preferably,

2.45≦A+B≦3.0 formula (7)

0.05≦A≦1.7 formula (8)

1.3≦B≦2.9 formula (9)

Even more preferably,

2.5≦A+≦2.95 formula (10)

0.1≦A≦1.55 formula (11)

1.4≦B≦2.85 formula (12)

As described above, a characteristic of the present invention is to introduce a propionate group, a butyrate group, a pentanoyl group and a hexanoyl group into cellulose to turn into cellulose acylate. The above ranges are preferred because the melting temperature can be lowered and thermal decomposition upon melt film forming can be suppressed. On the other hand, substitution degrees beyond this range are not preferred, because the temperature draws closer to melting temperature and the thermal decomposition temperature, which makes it more difficult to suppress thermal decomposition.

Either any one of the above cellulose acylates alone or two or more of them in combination may be used. A cellulose acylate into which a polymeric ingredient other than cellulose acylate has been properly mixed may also be used.

In the following a method for producing the cellulose acylate according to the present invention will be described in detail. The raw material cotton for the cellulose acylate according to the present invention or process for synthesizing the same are described in detail in Journal of Technical Disclosure (Laid-Open No. 2001-1745, issued on Mar. 15, 2001, Japan Institute of Invention and Innovation), pp. 7-12.

### (Raw Materials and Pretreatment)

As a raw material for cellulose, one from broadleaf pulp, conifer pulp or cotton linter is preferably used. As a raw material for cellulose, a material of high purity whose α-cellulose content is 92% by mass or higher and 99.9% by mass or lower is preferably used. When the raw material for cellulose is a film-like or bulk material, it is preferable to crush it in advance, and it is preferable to crush the material to such a degree that the cellulose is in the form of fluff.

### (Activation)

It is preferred to subject the material for cellulose to the treatment (activation) of contacting with an activating agent prior to acylation. As the activating agent, a carboxylic acid or water can be used. As the adding method, a suitable method can be selected from among, for example, a spraying method, a dropwise adding method and a dipping method.

carboxylic acids preferably used as an activator are those having 2 or more and 7 or less carbon atoms (e.g. acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid, heptanoic acid, cyclohexanecarboxylic acid and benzoic acid), more preferably acetic acid, propionic acid and butyric acid, and particularly preferably acetic acid.

In activation, it is preferable to add, as needed, a catalyst for acylation such as sulfuric acid in an amount of 0.1% by mass to 10% by mass based on the mass of the cellulose. Also, two or more kinds of activating agents may be used in combination or an acid anhydride of a carboxylic acid having 2 to 7 carbon atoms may also be added.

The addition amount of the activating agent is preferably 5% by mass or more, more preferably 10% by mass or more, particularly preferably 30% by mass or more, based on the mass of cellulose. As to the upper limit of the addition amount of the activating agent, there is no particular limit as long as productivity is not reduced. However, the addition amount is preferably equal to or less than a 100-fold amount by mass, more preferably equal to or less than a 20-fold amount by mass, particularly preferably equal to or less than a 10-fold amount by mass, based on the mass of cellulose.

The activation duration is preferably 20 minutes or longer. The maximum duration is not particularly limited, as long as it does not affect the productivity; however, the duration is preferably 72 hours or shorter, more preferably 24 hours or shorter and particularly preferably 12 hours or shorter. The activation temperature is preferably 0° C. or higher and 90° C. or lower, more preferably 15° C. or higher and 80° C. or lower, and particularly preferably 20° C. or higher and 60° C. or lower.

### (Acylation)

As a method for obtaining a cellulose-mixed acylate in the present invention, any one of the methods can be used in which two kinds of carboxylic anhydrides, as acylating agents, are added in the mixed state or one by one to react with cellulose; in which a mixed acid anhydride of two kinds of carboxylic acids (e.g. acetic acid-propionic acid-mixed acid anhydride) is used; in which a carboxylic acid and an acid anhydride of another carboxylic acid (e.g. acetic acid and propionic anhydride) are used as raw materials to synthesize a mixed acid anhydride (e.g. acetic acid-propionic acid-mixed acid anhydride) in the reaction system and the mixed acid anhydride is reacted with cellulose; and in which first a cellulose acylate whose substitution degree is lower than 3 is synthesized and the remaining hydroxyl group is acylated using an acid anhydride or an acid halide. As to synthesis for cellulose acylate having a large substitution degree at the 6-position, descriptions are given in official gazettes such as Japanese Patent Application Laid-Open Nos. 11-5851, 2002-212338 and 2002-338601.

### (Acid Anhydride)

Acid anhydrides of carboxylic acids preferably used are those of carboxylic acids having 2 or more and 7 or less carbon atoms, which include: for example, acetic anhydride, propionic anhydride, butyric anhydride, hexanoic anhydride and benzoic anhydride. More preferred are acetic anhydride, propionic anhydride, butyric anhydride, and hexanoic anhydride. Particularly preferred are acetic anhydride, propionic anhydride and butyric anhydride.

The acid anhydride is usually added in an amount more than the equivalent amount with respect to cellulose. That is, the acid anhydride is added in an amount of preferably from 1.1 to 50 equivalents, more preferably from 1.2 to 30 equivalents, and particularly preferably from 1.5 to 10 equivalents, with respect to the hydroxyl group of cellulose.

### (Catalyst)

As an acylation catalyst for the production of a cellulose acylate in the present invention, preferably a Bronsted acid or a Lewis acid is used. The definitions of Bronsted acid and Lewis acid are described in, for example, “Rikagaku Jiten (Dictionary of Physics and Chemistry)” 5^{th} edition (2000). Preferred examples of catalyst include sulfuric acid and perchloric acid, and sulfuric acid is particularly preferred. The preferred addition amount of the catalyst is from 0.1 to 30% by mass, more preferably from 1 to 15% by mass, and particularly preferably from 3 to 12% by mass, based on the mass of cellulose.

### (Solvent)

Upon conducting acylation, a solvent may be added for the purpose of adjusting viscosity, reaction rate, stirring properties and acyl substitution ratio. Preferable examples of such solvent include carboxylic acid, and more preferable are carboxylic acids having 2 to 7 carbon atoms (e.g., acetic acid, propionic acid, butyric acid, hexanoic acid and benzoic acid). Especially preferable are acetic acid, propionic acid and butyric acid. These solvents may be used in combination thereof.

### (Conditions for Acylation)

Upon conducting acylation, the acid anhydride and the catalyst and, as needed, the solvent may be mixed with each other, followed by mixing the resulting mixture with cellulose or, alternatively, these may separately and successively be mixed with cellulose. However, it is usually preferred that a mixture of the acid anhydride and the catalyst or a mixture of the acid anhydride, the catalyst and the solvent is prepared as an acylating agent before reaction with cellulose. In order to suppress an increase in temperature inside the reaction vessel due to heat of acylation reaction, it is preferred to previously cool the acylating agent.

Further, the acylating agent may be added to cellulose all at once or in portions. Also, cellulose may be added to the acylating agent all at once or in portions. The highest temperature reached during acylation is preferably no greater than 50° C. When the reaction temperature is equal to or lower than this temperature, there does not arise the problem of the depolymerization proceeding so much that production of a cellulose acylate having a polymerization degree suited for the use of the invention becomes difficult. Thus, such temperature range is preferred. The highest temperature reached in the acylation is preferably no greater than 45° C., more preferably no greater than 40° C., and particularly preferably no greater than 35° C. The lowest temperature of the reaction is preferably no lower than −50° C., more preferably no lower than −30° C., and particularly preferably no lower than −20° C. The acylation time is preferably 0.5 hours or more to 24 hours or less, more preferably 1 hour or more to 12 hours or less, and particularly preferably 1.5 hours or more to 10 hours or less.

### (Reaction Terminator)

In the method for producing the cellulose acylate to be used in the invention, it is preferred to add a reaction terminator after the acylation reaction. As the reaction terminator, any one that can decompose an acid anhydride may be used. Preferred examples thereof include water, alcohol (e.g., ethanol, methanol, propanol or isopropyl alcohol) and a composition containing them. It is preferable to add a mixture of a carboxylic acid such as acetic acid, propionic acid or butyric acid and water. As the carboxylic acid, acetic acid is particularly preferred. The carboxylic acid and water may be used in any proportion, but the content of water is preferably in the range of 5% to 80% by mass, more preferably 10% to 60% by mass, and particularly preferably 15% to 50% by mass.

### (Neutralizing Agent)

During or after the step of stopping the acylation reaction, a neutralizing agent or a solution thereof may be added in order to hydrolyze excess carboxylic anhydride remaining in the reaction system, neutralize part or whole of the carboxylic acid and the esterification catalyst or to adjust the amount of residual sulfate and the amount of residual metal.

Preferred examples of the neutralizing agent include ammonium, an organic quaternary ammonium, carbonates, hydrogencarbonates, organic acid salts (e.g., acetates, propionates, butyrates, benzoates, phthalates, hydrogenphthalates, citrates and tartrates), hydroxides and oxides of an alkali metal, a group II metal, a group III to XII metal or a group XIII to XV element. More preferred neutralizing agents are carbonates, hydrogencarbonates, organic acid salts, hydroxides or oxides of an alkali metal or a group II metal, and particularly preferred neutralizing agents are carbonates, hydrogencarbonates, acetates or hydroxides of sodium, potassium, magnesium or potassium. Examples of the solvent for the neutralizing agent include water, an organic acid (e.g., acetic acid, propionic acid or butyric acid) and a mixed solvent thereof.

### (Partial Hydrolysis)

The thus-obtained cellulose acylate has a total substitution degree of nearly 3 and, for the purpose of obtaining cellulose acylate having a desired substitution degree, it is generally conducted to maintain the obtained cellulose acylate at 20 to 90° C. for several minutes to several days in the presence of a small amount of a catalyst (generally, residual acylating catalyst such as sulfuric acid) and water to thereby partially hydrolyze the ester bond and reduce the acyl substitution degree of the cellulose acylate to a desired level (so-called ripening). It is preferred to completely neutralize, at the stage where a desired cellulose acylate is obtained, the catalyst remaining in the reaction system by using the above-described neutralizing agent or solution thereof to stop the partial hydrolysis. It is also preferred to add a neutralizing agent which generates a salt having a low solubility for the reaction solution (e.g., magnesium-carbonate or magnesium acetate) to thereby effectively remove the catalyst (e.g., sulfuric acid ester) in the solution or in a form bound to cellulose.

### (Filtration)

For the purpose of removing or reducing unreacted materials, slightly soluble salts and other foreign matters in the resultant cellulose acylate, it is preferred to conduct filtration of the reaction mixture. The filtration may be conducted at any step between completion of acylation and re-precipitation. It is also preferred to dilute with a suitable solvent prior to filtration for the purpose of controlling filtration pressure and handling properties. After undergoing filtration, a cellulose acylate solution is obtained.

### (Reprecipitation)

An intended cellulose acylate can be obtained by: mixing the cellulose acylate solution thus obtained into a poor solvent, such as water or an aqueous solution of a calboxylic acid (e.g. acetic acid and propionic acid), or mixing such a poor solvent into the cellulose acylate solution, to precipitate the cellulose acylate; washing the precipitated cellulose acylate; and subjecting the washed cellulose acylate to stabilization treatment. The reprecipitation may be performed continuously or in a batchwise operation.

### (Washing)

Preferably, the produced cellulose acylate undergoes washing treatment. Any washing solvent can be used, as long as it slightly dissolves the cellulose acylate and can remove impurities; however, generally water or hot water is used. The progress of washing may be traced by any means; however, preferred means of tracing include: for example, hydrogen ion concentration, ion chromatography, electrical conductivity, ICP (Inductively Coupled Plasma), elemental analysis, and atomic absorption spectrometry.

### (Stabilization)

To improve the stability of the cellulose acylate and reduce the odor of the carboxylic acid, it is preferable to treat the cellulose acylate having been washed with hot water with an aqueous solution of weak alkali (e.g. carbonate, hydrogencarbonate, hydroxide or oxide of sodium, potassium calcium, magnesium or aluminum).

### (Drying)

In the present invention, to adjust the water content of the cellulose acylate to a desirable value, it is preferable to dry the cellulose acylate. The drying temperature is preferably 0 to 200° C., more preferably 40 to 180° C., and particularly preferably 50 to 160° C. The water content of the cellulose acylate of the present invention is preferably 2% by mass or less, more preferably 1% by mass or less, and particularly preferably 0.7% by mass or less.

### (Form)

The cellulose acylate of the present invention can take various forms, such as particle, powder, fiber and bulk forms. However, as a raw material for films, the cellulose acylate is preferably in the particle form or in the powder form. Thus, the cellulose acylate after drying may be crushed or sieved to make the particle size uniform or improve the handleability. When the cellulose acylate is in the particle form, preferably 90% by mass or more of the particles used has a particle size of 0.5 to 5 mm. Further, preferably 50% by mass or more of the particles used has a particle size of 1 to 4 mm. Preferably, the particles of the cellulose acylate have a shape as close to a sphere as possible. And the apparent density of the cellulose acylate particles of the present invention is preferably 0.5 g/cm³ to 13 g/cm³, more preferably 0.7 g/cm³ to 1.2 g/cm³, and particularly preferably 0.8 g/cm³ to 1.15 g/cm³. The method for measuring the apparent density is specified in JIS K-7365. The cellulose acylate particles of the present invention preferably have an angle of repose of 10 to 70 degrees, more preferably 15 to 60 degrees, and particularly preferably 20 to 50 degrees.

### (Degree of Polymerization)

The average degree of polymerization of the cellulose acylate preferably used in the present invention is 100 to 700, preferably 120 to 600, and much more preferably 130 to 450. The average degree of polymerization can be determined by intrinsic viscosity method by Uda et al. (Kazuo Uda and Hideo Saitoh, Journal of the Society of Fiber Science and Technology, Japan, Vol. 18, No. 1, 105-120, 1962) or by the molecular weight distribution measurement by gel permeation chromatography (GPC). The determination of average degree of polymerization is described in detail in Japanese Patent Application Laid-Open No. 9-95538.

### (Synthetic Example of Cellulose Acylate)

A synthetic example of the cellulose acylate used in the present invention will now be described in more detail, but the present invention is not limited thereto.

An acylation agent (selected alone or in a combination of several depending on the intended degree of acyl substitution from among acetic acid; acetic anhydride, propionic acid, propionic anhydride, butyric acid and butyric anhydride) and sulfuric acid as a catalyst were added to cellulose. Acylation was carried out while maintaining the reaction temperature at 40° C. or lower. After the cellulose as the raw material had been consumed and acylation completed, heating was continued at 40° C. or lower, to thereby adjust the intended degree of polymerization. The resultant mixture was charged with aqueous acetic acid, and remaining acetic anhydride was hydrolyzed. Partial hydrolysis was then carried out by heating at 60° C. or lower, to adjust the total substitution degree. Remaining sulfuric acid was neutralized with excess magnesium acetate. Re-precipitation was carried out from aqueous acetic acid, and the resultant solution was repeatedly washed to thereby obtain cellulose acetate.

Depending on the intended degree of substitution and degree of polymerization, cellulose acylates having different degrees of substitution and degrees of polymerization can be synthesized by varying the composition of the acylation agent, the reaction temperature and time of the acylation, and the temperature and time of the partial hydrolysis.

(4) Other additives
(i) Matting agent

Preferably, fine particles are added as a matting agent. Examples of fine particles used in the present invention include: those of silicon dioxide, titanium dioxide, aluminum oxide, zirconium oxide, calcium carbonate, talc, clay, calcined kaolin, calcined calcium silicate, hydrated calcium silicate, aluminum silicate, magnesium silicate and calcium phosphate. Fine particles containing silicon are preferable because they can decrease the turbidity of the cellulose acylate film. Fine particles of silicon dioxide are particularly preferable. Preferably, the fine particles of silicon dioxide have an average primary particle size of 20 nm or less and an apparent specific gravity of 70 g/liter or more. Those having an average primary particle size as small as 5 to 16 nm are more preferable, because they enable the haze of the film produced to be decreased. The apparent specific gravity is preferably 90 to 200 g/liter or more and more preferably 100 to 200 g/liter more. The larger the apparent specific gravity, the more preferable, because fine particles of silicon dioxide having a larger apparent specific gravity make it possible to prepare a dispersion of higher concentration, thereby improving the haze and the agglomerates.

These fine particles generally form secondary particles having an average particle size of 0.1 to 3.0 μm, which exist as agglomerates of primary particles in a film and form irregularities 0.1 to 3.0 μm in size on the film surface. The average secondary particle size is preferably 0.2 μm or more and 1.5 μm or less, more preferably 0.4 μm or more and 1.2 μm or less, and most preferably 0.6 μm or more and 1.1 μm or less. The primary particle size and the secondary particle size are determined by observing the particles in the film with a scanning electron microscope and using the diameter of the circle circumscribing each particle as a particle size. The average particle size is obtained by averaging the 200 determinations resulting from observation at different sites.

As fine particles of silicon dioxide, those commercially available, such as Aerosil 8972, R972V, 8974, R812, 200, 200V, 300, R202, OX50 and TT600 (manufactured by Nippon Aerosil Co., LTD), can be used. As fine particles of zirconium oxide, those on the market under the trade name of Aerosil 8976 and R811 (manufactured by Nippon Aerosil Co., LTD) can be used. Of these fine particles, Aerosil 200V and Aerosil R972V are particularly preferable, because they are fine particles of silicon dioxide having an average primary particle size of 20 nm or less and an apparent specific gravity of 70 g/liter more and they produce a large effect of reducing friction coefficient of the optical film produced while keeping the turbidity of the same low.

### (ii) Other Additives

Various additives other than the above described matting agent, such as ultraviolet light absorbers (e.g. hydroxybenzophenone compounds, benzotriazole compounds, salicylate ester compounds and cyanoacrylate compounds), infrared absorbers, optical adjustors, surfactants and odor-trapping agents (e.g. amine), can be added to the cellulose acylate of the present invention. The materials preferably used are described in detail in Journal of Technical Disclosure Laid-Open No. 2001-1745 (issued on Mar. 15, 2001, Japan Institute of Invention and Innovation), pp. 17-22.

As infrared absorbers, for example, those described in Japanese Patent Application Laid-Open No. 2001-194522 can be used, while as ultraviolet light absorbers, for example, those described in Japanese Patent Application Laid-Open No. 2001-151901 can be used. Both the infrared absorber content and the ultraviolet light absorber content of the cellulose acylate are preferably 0.001 to 5% by mass.

Examples of optical adjustors include retardation adjustors. And those described in, for example, Japanese Patent Application Laid-Open Nos. 2001-166144, 2003-344655, 2003-248117 and 2003-66230 can be used. The use of such a retardation adjustor makes it possible to control the in-plane retardation (Re) and the retardation across the thickness (Rth) of the film produced. Preferably, the amount of the retardation adjustor added is 0 to 10% by mass, more preferably 0 to 8% by mass, and much more preferably 0 to 6% by mass.

### (5) Physical Properties of Cellulose Acylate Mixture

The above described cellulose acylate mixtures (mixtures of cellulose acylate, plasticizer, stabilizer and other additives) preferably satisfy the following physical properties.

### (i) Weight Loss Percentage Upon Heating

The term “weight loss percentage upon heating” means the ratio of weight reduction at 220° C. when a sample is heated from room temperature at a temperature increase rate of 10° C./minute under a nitrogen gas atmosphere. By preparing the above-described cellulose acylate mixture, the weight loss percentage upon heating can be 5% by mass or less. The weight loss percentage upon heating is more preferably 3% by mass or less, and even more preferably 1% by mass or less. By employing this condition, defects generated in the film (generation of bubbles) can be prevented.

### (ii) Melt Viscosity

The above-described cellulose acylate mixture preferably has a melt viscosity at 220° C., 1 sec⁻¹ of preferably 100 to 1,000 Pa·sec, more preferably 200 to 800 Pa·sec, and even more preferably 300 to 700 Pa·sec. By adjusting to such a high melt viscosity, the film is not extended (stretched) by the tension at the die outlet, and therefore the increase in optical anisotropy (retardation) caused by stretched orientation can be prevented. Such viscosities may be adjusted by any process, and are adjustable, for example, by the polymerization degree of cellulose acylate or the amount of additives such as a plasticizer.

### (6) Pelletization

Preferably, the above described cellulose acylate and additives are mixed and pelletized prior to melt film formation. In pelletization, it is preferable to dry the cellulose acylate and additives in advance; however, if a vented extruder is used, the drying step can be omitted. When drying is performed, a drying method can be employed in which the cellulose acylate and additives are heated in a heating oven at 90° C. for 8 hours or more, though drying methods applicable in the present invention are not limited to this. Pelletization can be performed in such a manner that after melting the above described cellulose acylate and additives at temperatures of 150° C. or higher and 250° C. or lower on a twin-screw kneading extruder, the molten mixture is extruded in the form of noodles, and the noodle-shaped mixture is solidified in water, followed by cutting. Pelletization may also be performed by underwater cutting in which the above described cellulose acylate and additives are melted on an extruder and extruded through a ferrule directly in water, and cutting is performed in water while carrying out extrusion.

Any known extruder, such as single screw extruder, non-intermeshing counter-rotating twin-screw extruder, intermeshing counter-rotating twin-screw extruder, intermeshing corotating twin-screw extruder, can be used, as long as it enables melt kneading.

Preferably, the pellet size is such that the cross section is 1 mm² or larger and 300 mm² or smaller and the length is 1 mm or longer and 30 mm or shorter and more preferably the cross section is 2 mm² or larger and 100 mm² or smaller and the length is 15 mm or longer and 10 mm or shorter.

In pelletization, the above described additives may be fed through a raw material feeding opening or a vent located midway along the extruder.

The number of revolutions of the extruder is preferably 10 rpm or more and 1000 rpm or less, more preferably 20 rpm or more and 700 rpm or less, and much more preferably 30 rpm or more and 500 rpm or less. If the rotational speed is lower than the above described range, the residence time of the cellulose acylate and additives is increased, which undesirably causes heat deterioration of the mixture, and hence decrease in molecular weight and increase in color change to yellow. Further, if the rotational speed is higher than the above described range, molecule breakage by shear is more likely to occur, which gives rise to problems of decrease in molecular weight and increase in crosslinked gel.

The extrusion residence time in pelletization is preferably 10 seconds or longer and 30 minutes or shorter, more preferably 15 seconds or longer and 10 minutes or shorter, and much more preferably 30 seconds or longer and 3 minutes or shorter. As long as the resin mixture is sufficiently melt, shorter residence time is preferable, because shorter residence time enables the deterioration of resin or occurrence of yellowish color to be suppressed.

### (7) Melt Film Formation

### (i) Drying

The cellulose acylate mixture palletized by the above described method is preferably used for the melt film formation, and the water content in the pellets is preferably decreased prior to the film formation.

In the present invention, to adjust the water content in the cellulose acylate to a desirable amount, it is preferable to dry the cellulose acylate. Drying is often carried out using an air dehumidification drier, but the method of drying is not limited to any specific one, as long as an intended water content is obtained (preferably drying is carried out efficiently by either any one of methods, such as heating, air blasting, pressure reduction and stirring, or two or more of them in combination, and more preferably a drying hopper having an insulating structure is used). The drying temperature is preferably 0 to 200° C., more preferably 40 to 180° C., and particularly preferably 60 to 150° C. Too low a drying temperature is not preferable, because if the drying temperature is too low, drying takes a longer time, and moreover, water content cannot be decreased to an intended value or lower. Too high a drying temperature is not preferable, either, because if the drying temperature is too high, the resin is adhere to cause, blocking. The amount of drying air used is preferably 20 to 400 m³/hour, more preferably 50 to 300 m³/hour, and particularly preferably 100 to 250 m³/hour. Too small an amount of drying air is not preferable, because if the amount of drying air is too small, drying cannot be carried out efficiently. On the other hand, using too large an amount of drying air is not economical. This is because the drying effect cannot be drastically improved further even by using excess amount of drying air. The dew point of the air is preferably 0 to −60° C., more preferably −10 to −50° C., and particularly preferably −20 to −40° C. The drying time is required to be at least 15 minutes or longer, preferably 1 hour or longer and more preferably 2 hours or longer. However, the drying time exceeding 50 hours dose not drastically decrease the water content further and it might cause deterioration of the resin by heat. Thus, an unnecessarily long drying time is not preferable. In the cellulose acylate of the present invention, the water content is preferably 1.0% by mass or lower, more preferably 0.1% by mass or lower, and particularly preferably 0.01% by mass or lower.

### (ii) Melt Extrusion

The above cellulose acylate resin is fed to a cylinder via a feed port of an extruder (different from the extruder used for the above pelletization). The resin is preferably dried by the above method to reduce the moisture content. To prevent oxidation of the molten resin due to the remaining oxygen, drying is more preferably performed in an inert atmosphere (nitrogen, etc) in an extruder or with vacuum evacuating using an extruder having a vent. The screw compression ratio of the extruder is set to 2.5 to 4.5, and the L/D is set to 20 to 70. The L/D is the ratio of the cylinder length to the cylinder bore diameter. The extrusion temperature is set to 190° C. to 240° C. When the temperature in the extruder is higher than 240° C., a cooler may be disposed between the extruder and the die.

Further, when the L/D is too small (below 20), melting and kneading may be insufficient, and minute crystals tend to remain in the produced cellulose acylate film. On the other hand, when the L/D too large (above 70), the residence time of the cellulose acylate in the extruder is too long, and the resin is more susceptible to being degraded. In addition, if the residence time is longer, breaking of the molecules occurs, whereby the molecular weight is reduced and the mechanical strength of the film is decreased. Therefore, to make it less likely for yellowing to appear on the film and less likely for stretching fractures to occur, L/D is preferably in the range of 20 to 70, more preferably 22 to 65, and especially preferably 24 to 50.

Preferably, the extrusion temperature is set to the above temperature range. The cellulose acylate film thus obtained has property values of a haze of 2.0% or less and yellowness index (YI value) of 10 or less.

Here, “haze” is an index of whether the extrusion temperature is too low or not; in other words, an index for determining the amount of crystal remaining in the produced cellulose acylate film. When the haze value is more than 2.0%, the strength of the produced cellulose acylate film may decrease and the film tends to be broken upon stretching. The yellowness index (YI value) is an index of whether the extrusion temperature is too high or not. A yellowness index (YI value) of 10 or less means that there is no problem of yellowing.

As to the types of extruders, generally single-screw extruders whose equipment cost is relatively low are often used. Types of the screw include a full-flight screw, a Maddock screw and a Dulmage screw. For cellulose acylate resins, which have relatively poor thermal stability, full-flight screws are preferred. Although it involves high equipment cost, a twin-screw extruder whose screw segment is modified and to which a vent port is provided along the body to be able to perform extrusion while discharging unnecessary volatile components may also be used. Twin-screw extruders are roughly classified into co-rotating types and counter-rotating types. Although both can be used, co-rotating types in which residence areas are not easily formed and which have high self-cleaning ability are preferred. Although twin-screw extruders require high equipment cost, they are suitable for producing a film of a cellulose acetate resin because they have high kneadability and high resin supply ability, enabling extrusion at low temperatures. By providing a vent port at an appropriate position, cellulose acylate pellets or powder which have not been dried can be directly used. Moreover, pieces of films produced during film forming can be directly reused without drying.

Although the screw has different diameters depending on the intended extrusion amount per unit time, the diameter is preferably 10 mm or more to 300 mm or less, more preferably 20 mm or more to 250 mm or less, and even more preferably 30 mm or more to 150 mm or less.

(iii) Filtration

To filter contaminants in the resin or avoid the damage to the gear pump caused by such contaminants, it is preferable to perform a so-called breaker-plate-type filtration which uses a filter medium provided at the extruder outlet. To filter contaminants with much higher precision, it is preferable to provide, after the gear pump, a filter in which a leaf-type disc filter is incorporated. Filtration can be performed with a single filtering section, or it can be multi-step filtration with a plurality of filtering sections. A filter medium with higher precision is preferably used however, taking into consideration the pressure resistance of the filter medium or the increase in filtration pressure due to the clogging of the filter medium, the filtration precision is preferably 15 μM to 3 μm and more preferably 10 μm to 3 μm. A filter medium with higher precision is particularly preferably used when a leaf-type disc filter is used to perform final filtration of contaminants. And in order to ensure suitability of the filter medium used, the filtration precision may be adjusted by the number of filter media loaded, taking into account the pressure resistance and filter life. From the viewpoint of being used at high temperature and high pressure, the type of the filter medium used is preferably a steel material. Of the steel materials, stainless steel or steel is particularly preferably used. From the viewpoint of corrosion, desirably stainless steel is used. A filter medium constructed by weaving wires or a sintered filter medium constructed by sintering, for example, metal long fibers or metal powder can be used. However, from the viewpoint of filtration precision and filter life, a sintered filter medium is preferably used.

### (iv) Gear Pump

To improve the thickness precision, it is important to decrease the fluctuation in the amount of the discharged resin and it is effective to provide a gear pump between the extruder and the die to feed a fixed amount of cellulose acylate resin through the gear pump. A gear pump is such that it includes a pair of gears—a drive gear and a driven gear—in mesh, and it drives the drive gear to rotate both the gears in mesh, thereby sucking the molten resin into the cavity through the suction opening formed on the housing and discharging a fixed amount of the resin through the discharge opening formed on the same housing. Even if there is a slight change in the resin pressure at the tip of the extruder, the gear pump absorbs the change, whereby the change in the resin pressure in the downstream portion of the film forming apparatus is kept very small, and the fluctuation in the film thickness is improved.

To improve the fixed-amount feeding performance of the gear pump, a method can also be used in which the pressure before the gear pump is controlled to be constant by varying the number of revolution of the screw. Or the use of a high-precision gear pump is also effective in which three or more gears are used to eliminate the fluctuation in gear of a gear pump.

Other advantages of using a gear pump are such that it makes possible the film formation while reducing the pressure at the tip of the screw, which would be expected to reduce the energy consumption, prevent the increase in resin temperature, improve the transportation efficiency, decrease in the residence time of the resin in the extruder, and decrease the L/D of the extruder. Furthermore, when a filter is used to remove contaminants, if a gear pump is not used, the amount of the resin fed from the screw can sometimes vary with increase in filtration pressure. However, this variation in the amount of resin fed from the screw can be eliminated by using a gear pump.

Preferably, the residence time of the resin, from the time the resin enters the extruder through the feed opening to the time it goes out of the die, is 2 minutes or longer and 60 minutes or shorter, more preferably 3 minutes or longer and 40 minutes or shorter, and much more preferably 4 minutes or longer and 30 minutes or shorter.

If the flow of polymer circulating around the bearing of the gear pump is not smooth, the seal by the polymer at the driving portion and the bearing portion becomes poor, which may cause the problem of producing wide fluctuations in measurements and feeding and extruding pressures. Thus, the gear pump (particularly clearances thereof) should be designed to match to the melt viscosity of the cellulose acylate resin. In some cases, the portion of the gear pump where the cellulose acylate resin resides can be a cause of the resin's deterioration. Thus, preferably the gear pump has a structure which allows the residence time of the cellulose acylate resin to be as short as possible. The tubes or adaptors that connect the extruder with a gear pump or a gear pump with the die should be so designed that they allow the residence time of the cellulose acylate resin to be as short as possible. Furthermore, to stabilize the extrusion pressure of the cellulose acylate whose melt viscosity is highly temperature-dependent, preferably the fluctuation in temperature is kept as narrow as possible. Generally, a band heater, which requires lower equipment costs, is often used for heating tubes; however, it is more preferable to use a cast-in aluminum heater which is less susceptible to temperature fluctuation. Further, to stabilize the discharge pressure of the extruder as described above, melting is preferably performed by heating with a heater dividing the barrel of the extruder into 3 to 20 areas.

### (v) Die

With the extruder constructed as above, the cellulose acylate is melted and continuously fed into a die, if necessary, through a filter or gear pump. Any type of commonly used die, such as T-die, fish-tail die or hanger coat die, may be used, as long as it allows the residence time of the molten resin to be short. Further, a static mixer can be introduced right before the T-die to increase the temperature uniformity. The clearance at the outlet of the T-die can be 1.0 to 5.0 times the film thickness, preferably 1.2 to 3 limes the film thickness, and more preferably 1.3 to 2 times the film thickness.

If the lip clearance is less than 1.0 time the film thickness, it is difficult to obtain a sheet whose surface state is good. Conversely, if the lip clearance is more than 5.0 times the film thickness, undesirably the thickness precision of the sheet is decreased. A die is very important equipment which determines the thickness precision of the film to be formed, and thus, one that can severely control the film thickness is preferably used.

Although commonly used dies can control the film thickness at intervals of 40 to 50 mm, dies of a type which can control the film thickness at intervals of 35 mm or less and more preferably at intervals of 25 mm or less are preferable. In the cellulose acylate resin, since its melt viscosity is highly temperature-dependent and shear-rate-dependent, it is important to design a die that causes the least possible temperature uniformity and the least possible flow-rate uniformity across the width. The use of an automated thickness adjusting die, which measures the thickness of the film downstream, calculates the thickness deviation and feeds the calculated result back to the thickness adjustment, is also effective in decreasing fluctuations in thickness in the long-term continuous production of the cellulose acylate film.

In producing films, a single-layer film forming apparatus, which requires lower producing costs, is generally used. However, depending on the situation, it is also possible to use a multi-layer film forming apparatus to produce a film having 2 types or more of structure, in which an outer layer is formed as a functional layer. Generally, preferably a functional layer is laminated thin on the surface of the cellulose acylate film, but the layer-layer ratio is not limited to any specific one.

### (vi) Casting

In the above-described process, cellulose acylate extruded in sheet form through a die is solidified by cooling on a cooling roller to give a film. In this step, contact between the cooling roller and the melt-extruded sheet-form cellulose acylate is preferably improved using an electrostatic application method, an air knife method, an air chamber method, a vacuum nozzle method or a touch roll method. Such methods for improving contact may be performed on the entire surface of the melt-extruded sheet or on some part. Particularly, a method called “edge pinning”; in which only both edges of the film are adhered, is often employed, but the method is not limited thereto.

Preferably, the molten resin sheet is cooled little by little using a plurality of cooling rollers. Generally, such cooling is often performed using 3 cooling rollers, but the number of cooling rollers used is not limited to 3. The diameter of the cooling rollers is preferably 100 mm or larger and 1000 mm or smaller and more preferably 150 mm or larger and 1000 mm or smaller. The spacing between the two adjacent rollers of the plurality of rollers is preferably 1 mm or larger and 50 mm or smaller and more preferably 1 mm or larger and 30 mm or smaller, in terms of face—face spacing.

The temperature of cooling rollers is preferably 60° C. or higher and 160° C. or lower, more preferably 70° C. or higher and 150° C. or lower, and much more preferably 80° C. or higher and 140° C. or lower. The cooled and solidified sheet is then stripped off from the cooling rollers, passed through take-off rollers (a pair of nip rollers), and wound up. The wind-up speed is preferably 10 m/min or higher and 100 m/min or lower, more preferably 15 m/min or higher and 80 m/min or lower, and much more preferably 20 m/min or higher and 70 m/min or lower.

The width of the film thus formed is preferably 0.7 m or more and 5 m or less, more preferably 1 m or more and 4 m or less, and much more preferably 1.3 m or more and 3 m or less. The thickness of the unstretched film thus obtained is preferably 30 μm or more and 400 μm or less, more preferably 40 μm or more and 300 μm or less, and much more preferably 50 μm or more and 200 μm or less.

When so-called touch roll method is used, the surface of the touch roll used may be made of resin, such as rubber or Teflon™, or metal. A roll, called as flexible roll, can also be used whose surface gets a little depressed by the pressure of a metal roll having a decreased thickness when the flexible roll and the metal roll touch with each other, and their pressure contact area is increased.

The temperature of the touch roll is preferably 60° C. or higher and 160° C. or lower, more preferably 70° C. or higher and 150° C. or lower, and much more preferably 80° C. or higher and 140° C. or lower.

(vii) Winding Up

Preferably, the sheet thus obtained is wound up with its edges trimmed away. The portions having been trimmed off may be reused as a raw material for the same kind of film or a different kind of film, after undergoing grinding or after undergoing granulation, or depolymerization or re-polymerization depending on the situation. Any type of trimming cutter, such as a rotary cutter, shearing blade or knife, may be used. The material of the cutter may be either carbon steel or stainless steel. Generally, a carbide-tipped blade or ceramic blade is preferably used, because use of such a blade makes the life of a cutter longer and suppresses the production of cuttings.

It is also preferable, from the viewpoint of preventing the occurrence of scratches on the sheet, to provide, prior to winding up, a laminating film at least on one side of the sheet. Preferably, the wind-up tension is 1 kg/m (in width) or higher and 50 kg/m (in width) or lower, more preferably 2 kg/m (in width) or higher and 40 kg/m (in width) or lower, and much more preferably 3 kg/m (in width) or higher and 20 kg/m (in width) or lower. If the wind-up tension is lower than 1 kg/m (in width), it is difficult to wind up the film uniformly. Conversely, if the wind-up tension is higher than 50 kg/m (in width), undesirably the film is too tightly wound, whereby the appearance of wound film deteriorates, and the knot portion of the film is stretched due to the creep phenomenon, causing surging in the film, or residual double refraction occurs due to the extension of the film. Preferably, the winding up is performed while detecting the wind-up tension with a tension control provided midway along the line and controlling the same to be constant. When there is a difference in the film temperature depending on the spot on the film forming line, a slight difference in the film length can sometimes be created due to thermal expansion, and thus, it is necessary to adjust the draw ratio of the nip rolls so that tension higher than a prescribed one should not be applied to the film.

Preferably, the winding up of the film is performed while tapering the amount of the film to be wound according to the winding diameter so that a proper wind-up tension is kept, though it can be performed while keeping the wind-up tension constant by the control with the tension control. Generally, the wind-up tension is decreased little by little with increase in the winding diameter; however, it can sometimes be preferable to increase the wind-up tension with increase in the winding diameter.

(viii) Physical Properties of Unstretched Cellulose Acylate Film

In the unstretched cellulose acylate film thus obtained, preferably Re=0 to 20 nm and Rth=0 to 80 nm, more preferably Re=0 to 15 nm and Rth=0 to 70 nm, and much more preferably Re=0 to 10 nm and Rth=0 to 60 nm. Re and Rth represent in-plane retardation and across-the-thickness retardation, respectively. Re is measured using KOBRA 21ADH (manufactured by Oji Scientific Instruments) while allowing light to enter the unstretched cellulose acylate film normal to its surface. Rth is calculated based on three retardation measurements: the Re measured as above, and the Rth measured while allowing light to enter the film from the direction inclined at angles of +40°, −40°, respectively, to the direction normal to the film using the slow axis in plane as a tilt axis (rotational axis). Preferably, the angle θ between the direction of the film formation (across the length) and the slow axis of the Re of the film is made as close to 0°, +90° or −90° as possible. The film has a total light transmittance of preferably 90% or more, more preferably 91% or more, and even more preferably 98% or more. Haze is preferably no greater than 1%, more preferably no greater than 0.8%, and even more preferably no greater than 0.6%.

Preferably, the thickness non-uniformity both in the longitudinal direction and the transverse direction is 0% or more and 4% or less, more preferably 0% or more and 3% or less, and much more preferably 0% or more and 2% or less. Preferably, the modulus in tension is 1.5 kN/mm² or more and 3.5 kN/mm² or less, more preferably 1.7 kN/mm² or more and 2.8 kN/mm² or less, and much more preferably 1.8 kN/mm² or more and 2.6 kN/mm² or less. Preferably, the breaking extension is 3% or more and 100% or less, more preferably 5% or more and 80% or less, and much more preferably 8% or more and 50% or less.

Preferably, the Tg (this indicates the Tg of the film, that is, the Tg of the mixture of cellulose acylase and additives) is 95° C. or higher and 145° C. or lower, more preferably 100° C. or higher and 140° C. or lower, and much more preferably 105° C. or higher and 135° C. or lower. Preferably, the dimensional change by heat at 80° C. per day is 0% or higher±1% or less both in the longitudinal direction and the transverse direction, more preferably 0% or higher±0.5% or less, and much more preferably 0% or higher 0.3% or less. Preferably, the water permeability at 40° C., 90% rh is 300 g/m²·day or higher and 1000 g/m²·day or lower, more preferably 400 g/m²·day or higher and 900 g/m²·day or lower, and much more preferably 500 g/m²·day or higher and 800 g/m²·day or lower. Preferably, the average water content at 25° C., 80% rh is 1% by mass or higher and 4% by mass or lower, more preferably 12% by mass or higher and 3% by mass or lower, and much more preferably 1.5% by mass or higher and 25% by mass or lower.

### (8) Stretching

The film formed by the above described process may be stretched. The Re and Rth of the film can be controlled by stretching.

Preferably, stretching is carried out at temperatures of Tg or higher and Tg+50° C. or lower, more preferably at temperatures of Tg+3° C. or higher and Tg+30° C. or lower, and much more preferably at temperatures of Tg+5° C. or higher and Tg+20° C. or lower. Preferably, the stretch magnification is 1% or higher and 300% or lower at least in one direction, more preferably 2% or higher and 250% or lower, and much more preferably 3% or higher and 200% or lower. The stretching can be performed equally in both longitudinal and transverse directions; however, preferably it is performed unequally so that the stretch magnification in one direction is larger than that of the other direction. Either the stretch magnification in the longitudinal direction (MD) or that in the transverse direction (ID) may be made larger. Preferably, the smaller value of the stretch magnification is 1% or more and 30% or less, more preferably 2% or more and 25% or less, and much more preferably 3% or more and 20% or less. Preferably, the larger one is 30% or more and 300% or less, more preferably 35% or more and 200% or less, and much more preferably 40% or more and 150% or less. The stretching operation can be carried out in one step or in a plurality of steps. The term “stretch magnification” used herein means the value obtained using the following equation.

Stretch magnification(%)=100×{(length after stretching)−(length before stretching)}/(length before stretching)

The stretching may be performed in the longitudinal direction by using 2 or more pairs of nip rolls and controlling the peripheral velocity of the pairs of nip rolls so that the velocity of the pair on the outlet side is faster than that of the other one(s) (longitudinal stretching) or in the transverse direction (in the direction perpendicular to the longitudinal direction) while allowing both ends of the film to be gripped by a chuck (transverse stretching). Further, the stretching may be performed using the simultaneous biaxial stretching method described in Japanese Patent Application Laid-Open Nos. 2000-37772, 2001-113591 and 2002-103445.

In the longitudinal stretching, the Re-to-Rth ratio can be freely controlled by controlling the value obtained by dividing the distance between two pairs of nip rolls by the width of the film (length-to-width ratio). In other words, the ratio Rth/Re can be increased by decreasing the length-to-width ratio. Further, Re and Rth can also be controlled by combining the longitudinal stretching and the transverse stretching. In other words, Re can be decreased by decreasing the difference between the percent of longitudinal sketch and the percent of the transverse stretch, while Re can be increased by increasing the difference between the same.

Preferably, the Re and Rth of the cellulose acylate film thus stretched satisfy the following formulas,

Rth≧Re

200 nm≧Re≧0 nm

500 nm≧Rth≧30 nm; and more preferably,

Rth≧Re×1.1

150 nm≧Re≧10 nm

400 nm≧Rth≧50 nm; and even more preferably

Rth≧Re×1.2

100 nm≧Re≧20 nm

350 nm≧Rth≧80 nm

The closer the angle θ formed between the film forming direction (longitudinal direction) and the film Re slow axis is to 0°, +90° or −90°, the better it is. That is, for longitudinal stretching, the closer to 0° the better, so that 0±3° is preferable, 0±2° is more preferable, and 0±1° is even more preferable. For transverse stretching, 90±3° or −90±3° is preferable, 90±2° or −90±2° is more preferable, and 90±1° or −90±1° is even more preferable.

Preferably, the thickness of the cellulose acylate film after stretching is 15 μm or more and 200 μm or less, more preferably 30 μm or more and 170 μm or less, and much more preferably 40 μm or more and 140 μm or less. Preferably, the thickness non-uniformity is 0% or more and 3% or less in both the longitudinal and transverse directions, more preferably 0% or more and 2% or less, and much more preferably 0% or more and 1% or less.

The physical properties of the stretched cellulose acylate film are preferably in the following range.

Preferably, the modulus in tension is 15 kN/mm² or more and less than 3.0 kN/mm², more preferably 1.7 kN/mm² or more and 2.8 kN/mm² or less, and much more preferably 1.8 kN/mm² or more and 2.6 kN/mm² or less. Preferably, the breaking extension is 3% or more and 100% or less, more preferably 5% or more and 80% or less, and much more preferably 8% or more and 50% or less. Preferably, the Tg (this indicates the Tg of the film, that is, the Tg of the mixture of cellulose acylate and additives) is 95° C. or higher and 145° C. or lower, more preferably 100° C. or higher and 140° C. or lower, and much more preferably 105° C. or higher and 135° C. or lower. Preferably, the dimensional change by heat at 80° C. per day is 0% or higher±1% or less both in the longitudinal direction and the transverse direction, more preferably 0% or higher±0.5% or less, and much more preferably 0% or higher±0.3% or less.

Preferably, the water permeability at 40° C., 90% is 300 g/m²·day or higher and 1000 g/m²·day or lower, more preferably 400 g/m²·day or higher and 900 g/m²·day or lower, and much more preferably 500 g/m²·day or higher and 800 g/m²·day or lower.

Preferably, the average water content at 25° C., 80% rh is 1% by mass or higher and 4% by mass or lower, more preferably 1.2% by mass or higher and 3% by mass or lower, and much more preferably 1.5% by mass or higher and 2.5% by mass or lower. The thickness is preferably 30 μm or more and 200 μm or less, more preferably 40 μm or more and 180 μm or less, and much more preferably 50 μm or more and 150 μm or less. The haze is 0% or more and 3% or less, more preferably 0% or more and 2% or less, and much more preferably 0% or more and 1% or less.

Total light transmittance is preferably no less than 90%, more preferably no less than 91%, and even more preferably no less than 98%.

### (9) Surface Treatment

The adhesion of both unstretched and stretched cellulose acylate films to each functional layer (e.g. undercoat layer and back layer) can be improved by subjecting them to surface treatment. Examples of types of surface treatment applicable include: treatment using glow discharge, ultraviolet irradiation, corona discharge, flame, or acid or alkali. The glow discharge treatment mentioned herein may be treatment using low-temperature plasma generated in a low-pressure gas at 0.1 Pa to 3,000 Pa (10⁻³ to 20 Torr). Or plasma treatment at atmospheric pressure is also preferable. Plasma excitation gases are gases that undergo plasma excitation under the above described conditions, and examples of such gases include: argon, helium, neon, krypton, xenon, nitrogen, carbon dioxide, flons such as tetrafluoromethane, and the mixtures thereof. These are described in detail in Journal of Technical Disclosure (Laid-Open No. 2001-1745, issued on Mar. 15, 2001, by Japan Institute of Invention and Innovation), 30-32. In the plasma treatment at atmospheric pressure, which has attracted considerable attention in recent years, for example, irradiation energy of 20 to 500 Kgy is used at 10 to 1000 Kev, and preferably irradiation energy of 20 to 300 Kgy is used at 30 to 500 Kev. Of the above described types of treatment, most preferable is alkali saponification, which is extremely effective as surface treatment for cellulose acylate films. Specific examples of such treatment applicable include: those described in Japanese Patent Application Laid-Open Nos. 2003-3266, 2003-229299, 2004-322928 and 2005-76088.

Alkali saponification may be carried out by immersing the film in a saponifying solution or by coating the film with a saponifying solution. The saponification by immersion can be achieved by allowing the film to pass through a bath, in which an aqueous solution of NaOH or KOH with pH of 10 to 14 has been heated to 20° C. to 80° C., over 0.1 to 10 minutes, neutralizing the same, water-washing the neutralized film, followed by drying.

The saponification by coating can be carried out using a coating method such as dip coating, curtain coating, extrusion coating, bar coating or E-coating. A solvent for alkali-saponification solution is preferably selected from solvents that allow the saponifying solution to have excellent wetting characteristics when the solution is applied to a transparent substrate; and allow the surface of a transparent substrate to be kept in a good state without causing irregularities on the surface. Specifically, alcohol solvents are preferable, and isopropyl alcohol is particularly preferable. An aqueous solution of surfactant can also be used as a solvent. As an alkali for the alkali-saponification coating solution, an alkali soluble in the above described solvent is preferable, and KOH or NaOH is more preferable. The pH of the alkali-saponification coating solution is preferably 10 or more and more preferably 12 or more. Preferably, the alkali saponification reaction is carried at room temperature for 1 second or longer and 5 minutes or shorter, more preferably for 5 seconds or longer and 5 minutes or shorter, and particularly preferably for 20 seconds or longer and 3 minutes or shorter. It is preferable to wash the saponifying solution-coated surface with water or an acid and wash the surface with water again after the alkali saponification reaction. The coating-type saponification and the removal of orientation layer described later can be performed continuously, whereby the number of the producing steps can be decreased. The details of these saponifying processes are described in, for example, Japanese Patent Application Laid-Open No. 2002-82226 and WO 02/46809.

To improve the adhesion of the unstretched or stretched cellulose acylate film to each functional layer, it is preferable to provide an undercoat layer on the cellulose acylate film. The undercoat layer may be provided after carrying out the above described surface treatment or without the surface treatment. The details of the undercoat layers are described in Journal of Technical Disclosure (Laid-Open No. 2001-1745, issued on Mar. 15, 2001, by Japan Institute of Invention and Innovation), 32.

These surface-treatment step and under-coat step can be incorporated into the final part of the film forming step, or they can be performed independently, or they can be performed in the functional-layer providing step.

### (10) Providing Functional Layer

Preferably, the stretched and unstretched cellulose acylate films of the present invention are combined with any one of the functional layers described in detail in Journal of Technical Disclosure (Laid-Open No. 2001-1745, issued on Mar. 15, 2001, by Japan Institute of Invention and Innovation), 32-45. Particularly preferable is providing a polarizing layer (polarizer), optical compensation layer (optical compensation film), antireflection layer (antireflection film) or hard coat layer.

### (i) Providing Polarizing Layer (Preparation of Polarizer)

### [Materials Used for Polarizing Layer]

At the present time, generally, commercially available polarizing layers are prepared by immersing stretched polymer in a solution of iodine or a dichroic dye in a bath so that the iodine or dichroic dye penetrates into the binder. Coating-type of polarizing films, represented by those manufactured by Optiva Inc., are also available as a polarizing film. Iodine or a dichroic dye in the polarizing film develops polarizing properties when its molecules are oriented in a binder. Examples of dichroic dyes applicable include: azo dye, stilbene dye, pyrazolone dye, triphenylmethane dye, quinoline dye, oxazine dye, thiazine dye and anthraquinone dye. The dichroic dye used is preferably water-soluble. The dichroic dye used preferably has a hydrophilic substitute (e.g. sulfo, amino, or hydroxyl). Example of such dichroic dyes includes: compounds described in Journal of Technical Disclosure, Laid-Open No. 2001-1745, 58, (issued on Mar. 15, 2001, by Japan Institute of Invention and Innovation).

Any polymer which is crosslinkable in itself or which is crosslinkable in the presence of a crosslinking agent can be used as a binder for polarizing films. And more than one combination thereof can also be used as a binder. Examples of binders applicable include: compounds described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000. Details of denatured polyvinyl alcohol are described in Japanese Patent Application Laid-Open Nos. 8-338913, 9-152509 and 9-316127. For polyvinyl alcohol and denatured polyvinyl alcohol, two or more kinds may be used in combination.

Preferably, the minimum of the binder thickness is 10 μm. For the maximum of the binder thickness; from the viewpoint of light leakage of liquid crystal display devices, preferably the binder has the smallest possible thickness. The thickness of the binder is preferably equal to or smaller than that of currently commercially available polarizer (about 30 μm), more preferably 25 μm or smaller, and much more preferably 20 μm or smaller.

The binder for polarizing films may be crosslinked. Polymer or monomer that has a crosslinkable functional group may be mixed into the binder. Or a crosslinkable functional group may be provided to the binder polymer itself. Crosslinking reaction is allowed to progress by means of light, heat or pH changes, and a binder having a crosslinked structure can be formed by crosslinking reaction. Examples of crosslinking agents applicable are described in U.S. Pat. (Reissued) No. 23297. Boron compounds (e.g. boric acid and borax) may also be used as a crosslinking agent. The amount of the crosslinking agent added to the binder is preferably 0.1 to 20% by mass of the binder. This allows polarizing devices to have good orientation characteristics and polarizing films to have good damp heat resistance.

The amount of the unreacted crosslinking agent after completion of the crosslinking reaction is preferably 1.0% by mass or less and more preferably 0.5% by mass or less. Restraining the unreacted crosslinking agent to such an amount improves the weatherability of the binder.

### [Stretching of Polarizing Film]

Preferably, a polarizing film is dyed with iodine or a dichroic dye after undergoing stretching (stretching process) or rubbing (rubbing process).

In the stretching process, preferably the stretching magnification is 2.5 to 30.0 and more preferably 3.0 to 10.0. Stretching can be dry stretching, which is performed in the air. Stretching can also be wet stretching, which is performed while immersing a film in water. The stretching magnification in the dry stretching is preferably 2.5 to 5.0, while the stretching magnification in the wet stretching is preferably 3.0 to 10.0. Stretching may be performed parallel to the MD direction (parallel stretching) or in an oblique (oblique stretching). These stretching operations may be performed at one time or in several installments. Stretching can be performed more uniformly even in high-ratio stretching if it is performed in several installments. Oblique stretching in which stretching is performed in an oblique while tilting a film at an angle of 10 degrees to 80 degrees is more preferable.

### (I) Parallel Stretching Process

Prior to stretching, a PVA film is swelled. The degree of swelling is 1.2 to 2.0 (ratio of mass before swelling to mass after swelling). After this swelling operation, the PVA film is stretched in a water-based solvent bath or in a dye bath in which a dichroic substance is dissolved at a bath temperature of 15 to 50° C., preferably 17 to 40° C. while continuously conveying the film via a guide roll etc. Stretching can be accomplished in such a manner as to grip the PVA film with 2 pairs of nip rolls and control the conveying speed of nip rolls so that the conveying speed of the latter pair of nip rolls is higher than that of the former pair of nip rolls. The stretching magnification is based on the length of PVA film after stretching/the length of the same in the initial state ratio (hereinafter the same), and from the viewpoint of the above described advantages, the stretching magnification is preferably 1.2 to 3.5 and more preferably 1.5 to 3.0. After this stretching operation, the film is dried at 50° C. to 90° C. to obtain a polarizing film.

### (II) Oblique Stretching Process

Oblique stretching can be performed by the method described in Japanese Patent Application Laid-Open No. 2002-86554 in which a tenter that projects on a tilt is used. This stretching is performed in the air; therefore, it is necessary to allow a film to contain water so that the film is easy to stretch. Preferably, the water content in the film is 5% or higher and 100% or lower, the stretching temperature is 40° C. or higher and 90° C. or lower, and the humidity during the stretching operation is preferably 50% rh or higher and 100% rh or lower.

The absorbing axis of the polarizing film thus obtained is preferably 10 degrees to 80 degrees, more preferably 30 degrees to 60 degrees, and much more preferably substantially 45 degrees (40 degrees to 50 degrees).

### [Lamination]

The above described stretched and unstretched cellulose acylate films having undergone saponification and the polarizing layer prepared by stretching are laminated to prepare a polarizer. They may be laminated in any direction, but preferably they are laminated so that the angle between the direction of the film casting axis and the direction of the polarizer stretching axis is 0 degree, 45 degrees or 90 degrees.

Any adhesive can be used for the lamination. Examples of adhesives applicable include: PVA resins (including denatured PVA such as acetoacetyl, sulfonic, carboxyl or oxyalkylen group) and aqueous solutions of boron compounds. Of these adhesives, PVA resins are preferable. The thickness of the adhesive layer is preferably 0.01 to 10 μm and particularly preferably 0.05 to 5 μm, on a dried layer basis.

Examples of configurations of laminated layers are as follows

a. A/P/A

b. A/P/B

c. A/P/T

d. B/P/B

e. B/P/T

where A represents an unstretched film of the present invention, B a stretched film of the present invention, T a cellulose triacetate film (Fujitack; trade name), and P a polarizing layer. In the configurations a, b, A and B may be cellulose acetate having the same composition, or they may be different. In the configuration d, two Bs may be cellulose acetate having the same composition, or they may be different, and their stretching rates may be the same or different. When sheets of polarizer are used as an integral part of a liquid crystal display device, they may be integrated into the display with either side of them facing the liquid crystal surface; however, in the configurations b, e, preferably B is allowed to face the liquid crystal surface.

In the liquid crystal display devices into which sheets of polarizer are integrated, usually a substrate including liquid crystal is arranged between two sheets of polarizer; however, the sheets of polarizer of a to e of the present invention and commonly used polarizer (T/P/T) can be freely combined. On the outermost surface of a liquid crystal display device, however, preferably a transparent hard coat layer, an anti-glare layer, antireflection layer and the like is provided, and as such a layer, any one of layers described later can be used.

Preferably, the sheets of polarizer thus obtained have a high light transmittance and a high degree of polarization. The light transmittance of the polarizer is preferably in the range of 30 to 50% at a wavelength of 550 nm, more preferably in the range of 35 to 50%, and most preferably in the range of 40 to 50%. The degree of polarization is preferably in the range of 90 to 100% at a wavelength of 550 nm, more preferably in the range of 95 to 100%, and most preferably in the range of 99 to 100%.

The sheets of polarizer thus obtained can be laminated with a λ/4 plate to create circularly polarized light. In this case, they are laminated so that the angle between the slow axis of the λ/4 plate and the absorbing axis of the polarizer is 45 degrees. Any λ/4 plate can be used to create circularly polarized light; however, preferably one having such wavelength-dependency that retardation is decreased with decrease in wavelength is used. More preferably, a polarizing film) having an absorbing axis which tilts 20 degrees to 70 degrees in the longitudinal direction and a λ/4 plate that includes an optically anisotropic layer made up of a liquid crystalline compound are used.

These sheets of polarizer may include a protective film laminated on one side and a separate film on the other side. Both protective film and separate film are used for protecting sheets of polarizer at the time of their shipping, inspection and the film.

### (ii) Providing Optical Compensation Layer (Preparation of Optical Compensation Film)

An optically anisotropic layer is used for compensating the liquid crystalline compound in a liquid crystal cell in black display by a liquid crystal display device. It is prepared by forming an orientation film on each of the stretched and unstretched cellulose acylate films and providing an optically anisotropic layer on the orientation film.

### [Orientation Film]

An orientation film is provided on the above described stretched and unstretched cellulose acylate films which have undergone surface treatment. This film has the function of specifying the orientation direction of liquid crystalline molecules. However, this film is not necessarily indispensable constituent of the present invention. This is because a liquid crystalline compound plays the role of the orientation film, as long as the oriented state of the liquid crystalline compound is fixed after it undergoes orientation treatment. In other words, the sheets of polarizer of the present invention can also be prepared by transferring only the optically anisotropic layer on the orientation film, where the orientation state is fixed, on the polarizer.

An orientation film can be provided using a technique such as rubbing of an organic compound (preferably polymer), oblique deposition of an inorganic compound, formation of a micro-groove-including layer, or built-up of an organic compound (e.g. ω-tricosanic acid, dioctadecyl methyl ammonium chloride, methyl stearate) by Langmur-Blodgett technique (LB membrane). Orientation films in which orientation function is produced by the application of electric field, electromagnetic field or light irradiation are also known.

Preferably, the orientation film is formed by rubbing of polymer. As a general rule, the polymer used for the orientation film has a molecular structure having the function of orienting liquid crystalline molecules.

In the present invention, preferably the orientation film has not only the function of orienting liquid crystalline molecules, but also the function of combining a side chain having a crosslinkable functional group (e.g. double bond) with the main chain or the function of introducing a crosslinkable functional group having the function of orienting liquid crystalline molecules into a side chain.

Either polymer which is crosslinkable in itself or polymer which is crosslinkable in the presence of a crosslinking agent can be used for the orientation film. And a plurality of the combinations thereof can also be used. Examples of such polymer include: those described in Japanese Patent Application Laid-Open No. 8-338913, column [0022], such as methacrylate copolymers, styrene copolymers, polyolefin, polyvinyl alcohol and denatured polyvinyl alcohol, poly(N-methylolacrylamide), polyester, polyimide, vinyl acetate copolymer, carboxymethylcellulose, and polycarbonate. Silane coupling agents can also be used as a polymer. Preferable are water-soluble polymers (e.g. poly(N-methylolacrylamide), carboxymethylcellulose, gelatin, polyvinyl alcohol and denatured polyvinyl alcohol), more preferable are gelatin, polyvinyl alcohol and denatured polyvinyl alcohol, and most preferable are polyvinyl alcohol and denatured polyvinyl alcohol. Use of two kinds of polyvinyl alcohol or denatured polyvinyl alcohol having different polymerization degrees in combination is particularly preferable. The saponification degree of polyvinyl alcohol is preferably 70 to 100% and more preferably 80 to 100%. The polymerization degree of polyvinyl alcohol is preferably 100 to 5000.

Side chains having the function of orienting liquid crystal molecules generally have a hydrophobic group as a functional group. The kind of the functional group is determined depending on the kind of liquid crystalline molecules and the oriented state required. For example, a denatured group of denatured polyvinyl alcohol can be introduced by copolymerization denaturation, chain transfer denaturation or block polymerization denaturation. Examples of denatured groups include: hydrophilic groups (e.g. carboxylic, sulfonic, phosphonic, amino, ammonium, amide and thiol groups); hydrocarbon groups with 10 to 100 carbon atoms; fluorine-substituted hydrocarbon groups; thioether groups; polymerizable groups (e.g. unsaturated polymerizable groups, epoxy group, azirinyl group); and alkoxysilyl groups (e.g. trialkoxy, dialkoxy, monoalkoxy). Specific examples of these denatured polyvinyl alcohol compounds include: those described in Japanese Patent Application Laid-Open No. 2000-155216, columns [0022] to [0145], Japanese Patent Application Laid-Open No. 2002-62426, columns [0018] to [0022].

Combining a side chain having a crosslinkable functional group with the main chain of the polymer of an orientation film or introducing a crosslinkable functional group into a side chain having the function of orienting liquid crystal molecules makes it possible to copolymerize the polymer of the orientation film and the polyfunctional monomer contained in the optically anisotropic layer. As a result, not only the molecules of the polyfunctional monomer, but also the molecules of the polymer of the orientation film and those of the polyfunctional monomer and the polymer of the orientation film are covalently firmly bonded together. Thus, introduction of a crosslinkable functional group into the polymer of an orientation film enables remarkable improvement in the strength of optical compensation films.

The crosslinkable functional group of the polymer of the orientation film preferably has a polymerizable group, like the polyfunctional monomer. Specific examples of such crosslinkable functional groups include: those described in Japanese Patent Application Laid-Open No. 2000-155216, columns [0080] to [0100]. The polymer of the orientation film can be crosslinked using a crosslinking agent, besides the above described crosslinkable functional groups.

Examples of crosslinking agents applicable include: aldehyde; N-methylol compounds; dioxane derivatives; compounds that function by the activation of their carboxyl group; activated vinyl compounds; activated halogen compounds; isoxazol; and dialdehyde starch. Two or more kinds of crosslinking agents may be used in combination. Specific examples of such crosslinking agents include: compounds described in Japanese Patent Application Laid-Open No. 2002-62426, columns [0023] to [0024]. Aldehyde, which is highly reactive, particularly glutaraldehyde is preferably used as a crosslinking agent.

The amount of the crosslinking agent added is preferably 0.1 to 20% by mass of the polymer and more preferably 05 to 15% by mass. The amount of the unreacted crosslinking agent remaining in the orientation film is preferably 1.0% by mass or less and more preferably 0.5% by mass or less. Controlling the amount of the crosslinking agent and unreacted crosslinking agent in the above described manner makes it possible to obtain a sufficiently durable orientation film, in which reticulation does not occur even after it is used in a liquid crystal display device for a long time or it is left in an atmosphere of high temperature and high humidity for a long time.

Basically, an orientation film can be formed by: coating the above described polymer, as a material for forming an orientation film, on a transparent substrate containing a crosslinking agent; heat drying (crosslinking) the polymer; and rubbing the same. The crosslinking reaction may be carried out at any time after the polymer is applied to the transparent substrate, as described above. When a water-soluble polymer, such as polyvinyl alcohol, is used as the material for forming an orientation film, the coating solution is preferably a mixed solvent of an organic solvent having an anti-foaming function (e.g. methanol) and water. The mixing ratio is preferably such that water:methanol=0:100 to 99:1 and more preferably 0:100 to 91:9. The use of such a mixed solvent suppresses the generation of foam, thereby significantly decreasing defects not only in the orientation film, but also on the surface of the optically anisotropic layer.

As a coating method for coating an orientation film, spin coating, dip coating, curtain coating, extrusion coating, rod coating or, roll coating is preferably used. Particularly preferably used is rod coating. The thickness of the film after drying is preferably 0.1 to 10 μm. The heat drying can be carried out at 20° C. to 110° C. To achieve sufficient crosslinking, preferably the heat drying is carried out at 60° C. to 100° C. and particularly preferably at 80° C. to 100° C. The drying time can be 1 minute to 36 hours, but preferably it is 1 minute to 30 minutes. Preferably, the pH of the coating solution is set to a value optimal to the crosslinking agent used. When glutaraldehyde is used, the pH is 4.5 to 55 and particularly preferably 5.

The orientation film is provided on the stretched and unstretched cellulose acylate films or on the above described undercoat layer. The orientation film can be obtained by crosslinking the polymer layer and providing rubbing treatment on the surface of the polymer layer, as described above.

The above described rubbing treatment can be carried out using a treatment method widely used in the treatment of liquid crystal orientation in LCD. Specifically, orientation can be obtained by rubbing the surface of the orientation film in a fixed direction with paper, gauze, felt, rubber or nylon, polyester fiber and the like. Generally the treatment is carried out by repeating rubbing a several tunes using a cloth in which fibers of uniform length and diameter have been uniformly transplanted.

In the rubbing treatment industrially carried out, rubbing is performed by bringing a rotating rubbing roll into contact with a running film including a polarizing layer. The circularity, cylindricity and deviation (eccentricity) of the rubbing roll are preferably 30 μm or less respectively. The wrap angle of the film wrapping around the rubbing roll is preferably 0.1 to 90°. However, as described in Japanese Patent Application Laid-Open No. 8-160430, if the film is wrapped around the rubbing roll at 360° or more, stable rubbing treatment is ensured. The conveying speed of the film is preferably 1 to 100 m/min. Preferably, the rubbing angle is properly selected from the range of 0 to 60°. When the orientation film is used in liquid crystal display devices, the rubbing angle is preferably 40° to 50° and particularly preferably 45°.

The thickness of the orientation film thus obtained is preferably in the range of 0.1 to 10 μm.

Then, liquid crystalline molecules of the optically anisotropic layer are oriented on the orientation film. After that, if necessary, the polymer of the orientation film and the polyfunctional monomer contained in the optically anisotropic layer are reacted, or the polymer of the orientation film is crosslinked using a crosslinking agent.

The liquid crystalline molecules used for the optically anisotropic layer include: rod-shaped liquid crystalline molecules and discotic liquid crystalline molecules. The rod-shaped liquid crystalline molecules and discotic liquid crystalline molecules may be either high-molecular-weight liquid crystalline molecules or low-molecular-weight liquid crystalline molecules, and they include low-molecule liquid crystalline molecules which have undergone crosslinking and do not show liquid crystallinity any more.

### [Rod-Shaped Liquid Crystalline Molecules]

Examples of rod-shaped liquid crystalline molecules preferably used include: azomethines, azoxys, cyanobiphenyls, cyanophenyl esters, benzoate esters, cyclohexane carboxylic acid phenyl esters, cyanophenyl cyclohexanes, cyano-substituted phenyl pyrimidines, alkoxy-substituted phenyl pyrimidines, phenyl dioxanes, tolans, and alkenyl cyclohexyl benzonitriles.

Rod-shaped liquid crystalline molecules also include metal complexes. Liquid crystal polymer that includes rod-shaped liquid crystalline molecules in its repeating unit can also be used as rod-shaped liquid crystalline molecules. In other words, rod-shaped liquid crystalline molecules may be bonded to (liquid crystal) polymer.

Rod-shaped liquid crystalline molecules are described in Kikan Kagaku Sosetsu (Survey of Chemistry, Quarterly), Vol. 22, Chemistry of Liquid Crystal (1994), edited by The Chemical Society of Japan, Chapters 4, 7 and 11 and in Handbook of Liquid Crystal Devices, edited by 142th Committee of Japan Society for the Promotion of Science, Chapter 3.

The index of birefringence of the rod-shaped liquid crystalline molecules is preferably in the range of 0.001 to 03. To allow the oriented state to be fixed, preferably the rod-shaped liquid crystalline molecules have a polymerizable group. As such a polymerizable group, a radically polymerizable unsaturated group or cationically polymerizable group is preferable. Specific examples of such polymerizable groups include: polymerizable groups and polymerizable liquid crystal compounds described in Japanese Patent Application Laid-Open No. 2002-62427, columns [0064] to [0086].

### [Discotic Liquid Crystalline Molecules]

Discotic liquid crystalline molecules include: benzene derivatives described in the research report by C. Destrade et al., Mol. Cryst. Vol. 71, 111 (1981); truxene derivatives described in the research report by C. Destrade et al., Mol. Cryst. Vol. 122, 141 (1985) and Physics lett, A, Vol. 78, 82 (1990); cyclohexane derivatives described in the research report by B. Kohne et al., Angew. Chem. Vol. 96, 70 (1984); and azacrown or phenylacetylene macrocycles described in the research report by J. M. Lehn et al., J. Chem. Commun., 1794 (1985) and in the research report by J. Zhang et al., L. Am. Chem. Soc. Vol. 116, 2655 (1994).

Discotic liquid crystalline molecules also include liquid crystalline compounds) having a structure in which straight-chain alkyl group, alkoxy group and substituted benzoyloxy group are substituted radially as the side chains of the mother nucleus at the center of the molecules. Preferably, the compounds are such that their molecules or groups of molecules have rotational symmetry and they can provide an optically anisotropic layer with a fixed orientation. In the ultimate state of the optically anisotropic layer formed of discotic liquid crystalline molecules, the compounds contained in the optically anisotropic layer are not necessarily discotic liquid crystalline molecules. The ultimate state of the optically anisotropic layer also contain compounds such that they are originally of low-molecular-weight discotic liquid crystalline molecules having a group reactive with heat or light, but undergo polymerization or crosslinking by heat or light, thereby becoming higher-molecular-weight molecules and losing their liquid crystallinity. Examples of preferred discotic liquid crystalline molecules are described in Japanese Patent Application Laid-Open No. 8-50206. And the details of the polymerization of discotic liquid crystalline molecules are described in Japanese Patent Application Laid-Open No. 8-27284.

To fix the discotic liquid crystalline molecules by polymerization, it is necessary to bond a polymerizable group, as a substitute, to the discotic core of the discotic liquid crystalline molecules. Compounds in which their discotic core and a polymerizable group are bonded to each other via a linking group are preferably used. With such compounds, the oriented state is maintained during the polymerization reaction. Examples of such compounds include: those described in Japanese Patent Application Laid-Open No. 2000-155216, columns [0151] to [0168].

In hybrid orientation, the angle between the long axis (disc plane) of the discotic liquid crystalline molecules and the plane of the polarizing film increases or decreases, across the depth of the optically anisotropic layer, with increase in the distance from the plane of the polarizing film. Preferably, the angle decreases with increase in the distance. The possible changes in angle include: continuous increase, continuous decrease, intermittent increase, intermittent decrease, change including both continuous increase and continuous decrease, and intermittent change including increase and decrease. The intermittent changes include the area midway across the thickness where the tilt angle does not change. Even if the change includes the area where the angle does not change, it does not matter as long as the angle increases or decreased as a whole. Preferably, the angle changes continuously.

Generally, the average direction of the long axis of the discotic liquid crystalline molecules on the polarizing film side can be adjusted by selecting the type of discotic liquid crystalline molecules or the material for the orientation film, or by selecting the method of rubbing treatment. On the other hand, generally the direction of the long axis (disc plane) of the discotic liquid crystalline molecules on the surface side (on the air side) can be adjusted by selecting the type of discotic liquid crystalline molecules or the type of the additives used together with the discotic liquid crystalline molecules.

Examples of additives used with the discotic liquid crystalline molecules include: plasticizer, surfactant, polymerizable monomer, and polymer. The degree of the change in orientation in the long axis direction can also be adjusted by selecting the type of the liquid crystalline molecules and that of additives, like the above described cases.

### [Other Compositions of Optically Anisotropic Layer]

Use of plasticizer, surfactant, polymerizable monomer, etc. together with the above described liquid crystalline molecules makes it possible to improve the uniformity of the coating film, the strength of the film and the orientation of liquid crystalline molecules. Preferably, such additives are compatible with the liquid crystalline molecules, and they can change the tilt angle of the liquid crystalline molecules or do not inhibit the orientation of the liquid crystalline molecules.

Examples of polymerizable monomers applicable include radically polymerizable or cationically polymerizable compounds. Preferable are radically polymerizable polyfunctional monomers which are copolymerizable with the above described polymerizable-group containing liquid crystalline compounds. Specific examples are those described in Japanese Patent Application Laid-Open No. 2002-296423, columns [0018] to [0020]. The amount of the above described compounds added is generally in the range of 1 to 50% by mass of the discotic liquid crystalline molecules and preferably in the range of 5 to 30% by mass.

Examples of surfactants include traditionally known compounds; however, fluorine compounds are particularly preferable. Specific examples of fluorine compounds include compounds described in Japanese Patent Application Laid-Open No. 2001-330725, columns [0028] to [0056].

Preferably, polymers used together with the discotic liquid crystalline molecules can change the tilt angle of the discotic liquid crystalline molecules.

Examples of polymers applicable include cellulose esters. Examples of preferred cellulose esters include those described in Japanese Patent Application Laid-Open No. 2000-155216, columns [0178]. Not to inhibit the orientation of the liquid crystalline molecules, the amount of the above described polymers added is preferably in the range of 0.1 to 10% by mass of the liquid crystalline molecules and more preferably in the range of 0.1 to 8% by mass.

The discotic nematic liquid crystal phase—solid phase transition temperature of the discotic liquid crystalline molecules is preferably 70 to 300° C. and more preferably 70 to 170° C.

### [Formation of Optically Anisotropic Layer]

An optically anisotropic layer can be formed by coating the surface of the orientation film with a coating fluid that contains liquid crystalline molecules and, if necessary, polymerization initiator or any other ingredients described later.

As a solvent used for preparing the coating fluid, an organic solvent is preferably used. Examples of organic solvents applicable include: amides (e.g. N,N-dimethylformamide); sulfoxides (e.g. dimethylsulfoxide); heterocycle compounds (e.g. pyridine); hydrocarbons (e.g. benzene, hexane); alkyl halides (e.g. chloroform, dichloromethane, tetrachloroethane); esters (e.g. methyl acetate, butyl acetate); ketones (e.g. acetone, methyl ethyl ketone); and ethers (e.g. tetrahydrofuran, 1,2-dimethoxyethane). Alkyl halides and ketones are preferably used. Two or more kinds of organic solvent can be used in combination.

Such a coating fluid can be applied by a known method (e.g. wire bar coating, extrusion coating, direct gravure coating, reverse gravure coating or die coating method).

The thickness of the optically anisotropic layer is preferably 0.1 to 20 μm, more preferably 0.5 to 15 μm, and most preferably 1 to 10 μm.

### [Fixation of Orientation State of Liquid Crystalline Molecules]

The oriented state of the oriented liquid crystalline molecules can be maintained and fixed. Preferably, the fixation is performed by polymerization. Types of polymerization include: heat polymerization using a heat polymerization initiator and photopolymerization using a photopolymerization initiator. For the fixation, photopolymerization is preferably used.

Examples of photopolymerization initiators include: a-carbonyl compounds (described in U.S. Pat. Nos. 2,367,661 and 2,367,670); acyloin ethers (described in U.S. Pat. No. 2,448,828); a-hydrocarbon-substituted aromatic acyloin compounds (U.S. Pat. No. 2,722,512); multi-nucleus quinone compounds (described in U.S. Pat. Nos. 3,046,127 and 2,951,758); combinations of triarylimidazole dimmer and p-aminophenyl ketone (described in U.S. Pat. No. 3,549,367); acridine and phenazine compounds (described in Japanese Patent Application Laid-Open No. 60-105667 and U.S. Pat. No. 4,239,850); and oxadiazole compounds (described in U.S. Pat. No. 4,212,970).

The amount of the photopolymerization initiators used is preferably in the range of 0.01 to 20% by mass of the solid content of the coating fluid and more preferably in the range of 0:5 to 5% by mass.

Light irradiation for the polymerization of liquid crystalline molecules is preferably performed using ultraviolet light. Irradiation energy is preferably in the range of 20 mJ/cm² to 50 J/cm², more preferably 20 to 5000 mJ/cm², and much more preferably 100 to 800 mJ/cm². To accelerate the photopolymerization, light irradiation may be performed under heat. A protective layer may be provided on the surface of the optically anisotropic layer.

Combining the optical compensation film with a polarizing layer is also preferable. Specifically, an optically anisotropic layer is formed on a polarizing film by coating the surface of the polarizing film with the above described coating fluid for an optically anisotropic layer. As a result, thin polarizer, in which stress generated with the dimensional change of polarizing film (distortion×cross-sectional area×modulus of elasticity) is small, can be prepared without using a polymer film between the polarizing film and the optically anisotropic layer. Installing the polarizer according to the present invention in a large-sized liquid crystal display device enables high-quality images to be displayed without causing problems such as light leakage.

Preferably, stretching is performed while keeping the tilt angle of the polarizing layer and the optical compensation layer to the angle between the transmission axis of the two sheets of polarizer laminated on both sides of a liquid crystal cell constituting LCD and the longitudinal or transverse direction of the liquid crystal cell. Generally the tilt angle is 45°. However, in recent years, transmissive-, reflective-, and semi-transmissive-liquid crystal display devices have been developed in which the tilt angle is not always 45°, and thus, it is preferable to adjust the stretching direction arbitrarily to the design of each LCD.

### [Liquid Crystal Display Devices]

Liquid crystal modes in which the above described optical compensation film is used will be described.

### (TN-Mode Liquid Crystal Display Devices)

TN-mode liquid crystal display devices are most commonly used as a color TFT liquid crystal display device and described in a large number of documents. The oriented state in a TN-mode liquid crystal cell in the black state is such that the rod-shaped liquid crystalline molecules stand in the middle of the cell while the rod-shaped liquid crystalline molecules lie near the substrates of the cell.

### (OCB-Mode Liquid Crystal Display Devices)

An OCB-mode liquid crystal cell is a bend orientation mode liquid crystal cell where the rod-shaped liquid crystalline molecules in the upper part of the liquid cell and those in the lower part of the liquid cell are oriented in substantially opposite directions (symmetrically). Liquid crystal display devices using a bend orientation mode liquid crystal cell are disclosed in U.S. Pat. Nos. 4,583,825 and 5,410,422. A bend orientation mode liquid crystal cell has a self-compensation function since the rod-shaped liquid crystalline molecules in the upper part of the liquid cell and those in the lower part are symmetrically oriented. Thus, this liquid crystal mode is also referred to as OCB (Optically Compensatory Bend) liquid crystal mode.

Like in the TN-mode cell, the oriented state in an OCB-mode liquid crystal cell in the black state is also such that the rod-shaped liquid crystalline molecules stand in the middle of the cell while the rod-shaped liquid crystalline molecules lie near the substrates of the cell.

### (VA-Mode Liquid Crystal Display Devices)

VA-mode liquid crystal cells are characterized in that in the cells, rod-shaped liquid crystalline molecules are oriented substantially vertically when no voltage is applied. The VA-mode liquid crystal cells include: (1) a Va-mode liquid crystal cell in a narrow sense where rod-shaped liquid crystalline molecules are oriented substantially vertically when no voltage is applied, while they are oriented substantially horizontally when a voltage is applied (Japanese Patent Application Laid-Open No. 2-176625); (2) a MVA-mode liquid crystal cell obtained by introducing multi-domain switching of liquid crystal into a VA-mode liquid crystal cell to obtain wider viewing angle, (SID 97, Digest of Tech. Papers (Proceedings) 28 (1997) 845), (3) a n-ASM-mode liquid crystal cell where rod-shaped liquid crystalline molecules undergo substantially vertical orientation when no voltage is applied, while they undergo twisted multi-domain orientation when a voltage is applied (Proceedings 58 to 59 (1998), Symposium, Japanese Liquid Crystal Society); and (4) a SURVAIVAL-mode liquid crystal cell (reported in LCD international 98).

### (IPS-Mode Liquid Crystal Display Devices)

IPS-mode liquid crystal cells are characterized in that in the cells, rod-shaped liquid crystalline molecules are oriented substantially horizontally in plane when no voltage is applied and switching is performed by changing the orientation direction of the crystal in accordance with the presence or absence of application of voltage. Specific examples of IPS-mode liquid crystal cells applicable include those described in Japanese Patent Application Laid-Open Nos. 2004-365941, 2004-12731, 2004-215620, 2002-221726, 2002-55341 and 2003-195333.

### (Other Modes of Liquid Crystal Display Devices)

In ECB-mode, STN (Supper Twisted Nematic)-mode, FLC (Ferroelectric Liquid Crystal)-mode, AFLC (Anti-ferroelectric Liquid Crystal)-mode, and ASM (Axially Symmetric Aligned Microcell)-mode cells, optical compensation can also be achieved with the above described logic. These cells are effective in any of the transmissive-, reflective-, and semi-transmissive-liquid crystal display devices. These are also advantageously used as an optical compensation sheet for GH (Guest-Host)-mode reflective liquid crystal display devices.

Examples of practical applications in which the cellulose derivative films described so far are used are described in Journal of Technical Disclosure (Laid-Open No. 2001-1745, Mar. 15, 2001, issued by Japan Institute of Invention and Innovation), 45-59.

### Providing Antireflection Layer (Antireflection Film)

Generally an antireflection film is made up of: a low-refractive-index layer which also functions as a stainproof layer; and at least one layer having a refractive index higher than that of the low-refractive-index layer (i.e. high-refractive-index layer and/or intermediate-refractive-index layer) provided on a transparent substrate.

Methods of forming a multi-layer thin film as a laminate of transparent thin films of inorganic compounds (e.g. metal oxides) having different refractive indices include: chemical vapor deposition (CVD); physical vapor deposition (PVD); and a method in which a film of a colloid of metal oxide particles is formed by sol-gel process from a metal compound such as a metal alkoxide and the formed film is subjected to post-treatment (ultraviolet light irradiation: Japanese Patent Application Laid-Open No. 9-157855, plasma treatment: Japanese Patent Application Laid-Open No. 2002-327310).

On the other hand, there are proposed a various antireflection films, as highly productive antireflection films, which are formed by coating thin films of a matrix and inorganic particles dispersing therein in a laminated manner.

There is also provided an antireflection film including an antireflection layer provided with anti-glare properties, which is formed by using an antireflection film formed by coating as described above and providing the outermost surface of the film with fine irregularities.

The cellulose acylate film of the present invention is applicable to antireflection films formed by any of the above described methods, but particularly preferable is the antireflection film formed by coating (coating type antireflection film).

### [Layer Configuration of Coating-Type Antireflection Film]

An antireflection film having at least on its substrate a layer construction of: intermediate-refractive-index layer, high-refractive-index layer and low-refractive-index layer (outermost layer) in this order is designed to have a refractive index satisfying the following relationship.

Refractive index of high-refractive-index layer>refractive index of intermediate-refractive-index layer>refractive index of transparent substrate>refractive index of low-refractive-index layer, and a hard coat layer may be provided between the transparent substrate and the intermediate-refractive-index layer.

The antireflection film may also be made up of intermediate-refractive-index hard coat layer, high-refractive-index layer and low-refractive-index layer.

Examples of such antireflection films include: those described in Japanese Patent Application Laid-Open Nos. 8-122504, 8-110401, 10-300902, 2002-243906 and 2000-111706. Other functions may also be imparted to each layer. There are proposed, for example, antireflection films that include a stainproofing low-refractive-index layer or anti-static high-refractive-index layer (e.g. Japanese Patent Application Laid-Open Nos. 10-206603 and 2002-243906).

The haze of the antireflection film is preferably 5% or less and more preferably 3% or less. The strength of the film is preferably H or higher; by pencil hardness test in accordance with JIS K5400, more preferably 2H or higher, and most preferably 3H or higher.

### [High-Refractive-Index Layer and Intermediate-Refractive-Index Layer]

The layer of the antireflection film having a high refractive index consists of a curable film that contains at least ultra-fine particles of high-refractive-index inorganic compound having an average particle size of 100 nm or less; and a matrix binder.

Fine particles of high-refractive-index inorganic compound include: for example, those of inorganic compounds having a refractive index of 1.65 or more and preferably 1.9 or more. Specific examples of such inorganic compounds include: oxides of Ti, Zn, Sb, Sn, Zr, Ce, Ta, La or In; and composite oxides containing these metal atoms.

Methods of forming such ultra-fine particles include: for example, treating the particle surface with a surface treatment agent (e.g. a silane coupling agent, Japanese Patent Application Laid-Open Nos. 11-295503, 11-153703, 2000-9908, an anionic compound or organic metal coupling agent, Japanese Patent Application Laid-Open No. 2001-310432 etc.); allowing particles to have a core-shell structure in which a core is made up of high-refractive-index particle(s) (Japanese Patent Application Laid-Open No. 2001-166104 etc.); and using a specific dispersant together (Japanese Patent Application Laid-Open No. 11-153703, U.S. Pat. No. 6,210,858B1, Japanese Patent Application Laid-Open No. 2002-2776069, etc.).

Materials used for forming a matrix include: for example, conventionally known thermoplastic resins and curable resin films.

Further, as such a material, at least one composition is preferable which is selected from the group consisting of: a composition including a polyfunctional compound that has at least two radically polymerizable and/or cationically polymerizable group; an organic metal compound containing a hydrolytic group; and a composition as a partially condensed-product of the above organic metal compound. Examples of such materials include: compounds described in Japanese Patent Application Laid-Open Nos. 2000-47004, 2001-315242, 2001-31871 and 2001-296401.

A curable film prepared using a colloidal metal oxide obtained from the hydrolyzed condensate of metal alkoxide and a metal alkoxide composition is also preferred. Examples are described in Japanese Patent. Application Laid-Open No. 2001-293818.

The refractive index of the high-refractive-index layer is generally 1.70 to 2.20. The thickness of the high-refractive-index layer is preferably 5 nm to 10 μm and more preferably 10 nm to 1 μm.

The refractive index of the intermediate-refractive-index layer is adjusted to a value between the refractive index of the low-refractive-index layer and that of the high-refractive-index layer. The refractive index of the intermediate-refractive-index layer is preferably 1.50 to 1.70.

### [Low-Refractive-Index Layer]

The low-refractive-index layer is formed on the high-refractive-index layer sequentially in the laminated manner. The refractive index of the low-refractive-index layer is 1.20 to 1.55 and preferably 1.30 to 1.50.

Preferably, the low-refractive-index layer is formed as the outermost layer having scratch resistance and stainproofing properties. As means of significantly improving scratch resistance, it is effective to provide the surface of the layer with slip properties, and conventionally known thin film forming means that includes introducing silicone or fluorine is used.

The refractive index of the fluorine-containing compound is preferably 1.35 to 1.50 and more preferably 136 to 1.47. The fluorine-containing compound is preferably a compound that includes a crosslinkable or polymerizable functional group containing fluorine atom in an amount of 35 to 80% by mass.

Examples of such compounds include: compounds described in Japanese Patent Application Laid-Open No. 9-222503, columns [0018] to [0026], Japanese Patent Application Laid-Open No. 11-38202, columns [0019] to [0030], Japanese Patent Application Laid-Open No. 2001-40284, columns [0027] to [0028], Japanese Patent Application Laid-Open No. 2000-284102, etc.

A silicone compound is preferably such that it has a polysiloxane structure, it includes a curable or polymerizable functional group in its polymer chain, and it has a crosslinking structure in the film. Examples of such silicone compounds include: reactive silicone (e.g. SILAPLANE manufactured by Chisso Corporation); and polysiloxane having a silanol group on each of its ends (one described in Japanese Patent Application Laid-Open No. 11-258403).

The crosslinking or polymerization reaction for preparing such fluorine-containing polymer and/or siloxane polymer containing a crosslinkable or polymerizable group is preferably carried out by radiation of light or by heating simultaneously with or after applying a coating composition for forming an outermost layer, which contains a polymerization initiator, a sensitizing agent, etc.

A sol-gel cured film is also preferable which is obtained by curing the above coating composition by the condensation reaction carried out between an organic metal compound, such as silane coupling agent, and silane coupling agent containing a specific fluorine-containing hydrocarbon group in the presence of a catalyst.

Examples of such films include: those of polyfluoroalkyl-group-containing silane compounds or the partially hydrolyzed and condensed compounds thereof (compounds described in Japanese Patent Application Laid-Open Nos. 58-142958, 58-147483, 58-147484, 9-157582 and 11-106704); and silyl compounds that contain “perfluoroalkyl ether” group as a fluoline-containing long-chain group (compounds described in Japanese Patent Application Laid-Open Nos. 2000-117902, 2001-48590 and 2002-53804).

The low-refractive-index layer can contain additives other than the above described ones, such as filler (e.g. low-refractive-index inorganic compounds whose primary particles have an average particle size of 1 to 150 nm, such as silicon dioxide (silica) and fluorine-containing particles (magnesium fluoride, calcium fluoride, barium fluoride); organic fine particles described in Japanese Patent Application Laid-Open No. 11-3820, columns [0020] to [0038]), silane coupling agent, slippering agent and surfactant.

When located under the outermost layer, the low-refractive-index layer may be formed by vapor phase method (vacuum evaporation, spattering, ion plating, plasma CVD, etc.). From the viewpoint of reducing producing costs, coating method is preferable.

The thickness of the low-refractive-index layer is preferably 30 to 200 nm, more preferably 50 to 150 nm, and most preferably 60 to 120 nm.

### [Hard Coat Layer]

A hard coat layer is provided on the surface of both stretched and unstretched cellulose acylate films so as to impart physical strength to the antireflection film. Particularly preferably the hard coat layer is provided between the stretched cellulose acylate film and the above described high-refractive-index layer and between the unstretched cellulose acylate film and the above described high-refractive-index layer. It is also preferable to provide the hard coat layer directly on the stretched and unstretched cellulose acylate films by coating without providing an antireflection layer.

Preferably, the hard coat layer is formed by the crosslinking reaction or polymerization of compounds curable by light and/or heat. Preferred curable functional groups are photopolymerizable functional groups, and organic metal compounds having a hydrolytic functional group are preferably organic alkoxy silyl compounds.

Specific examples of such compounds include the same compounds as illustrated in the description of the high-refractive-index layer.

Specific examples of compositions that constitute the hard coat layer include: those described in Japanese Patent Application Laid-Open Nos. 2002-144913, 2000-9908 and WO 0/46617.

The high-refractive-index layer can also serve as a hard coat layer. In this case, it is preferable to form the hard coat layer using the technique described in the description of the high-refractive-index layer so that fine particles are contained in the hard coat layer in the dispersed state.

The hard coat layer can also serves as an anti-glare layer (described later), if particles having an average particle size of 0.2 to 10 μm are added to provide the layer with the anti-glare function.

The thickness of the hard coat layer can be properly designed depending on the applications for which it is used. The thickness of the hard coat layer is preferably 0.2 to 10 μm and more preferably 0.5 to 7 μm.

The strength of the hard coat layer is preferably H or higher, by pencil hardness test in accordance with JIS K5400, more preferably 2H or higher, and much more preferably 3H or higher. The hard coat layer having a smaller abrasion loss in test, before and after Taber abrasion test conducted in accordance with JIS K5400, is more preferable.

### [Forward Scattering Layer]

A forward scattering layer is provided so that it provides, when applied to liquid crystal display devices, the effect of improving viewing angle when the angle of vision is tilted up-, down-, right- or leftward. The above described hard coat layer can also serve as a forward scattering layer, if fine particles with different refractive index are dispersed in it.

Example of such layers include: those described in Japanese Patent Application Laid-Open No. 11-38208 where the coefficient of forward scattering is specified; those described in Japanese Patent Application Laid-Open No. 2000-199809 where the relative refractive index of transparent resin and fine particles are allowed to fall in the specified range; and those described in Japanese Patent Application Laid-Open No. 2002-107512 wherein the haze value is specified to 40% or higher.

### [Other Layers]

Besides the above described layers, a primer layer, anti-static layer, undercoat layer or protective layer may be provided.

### [Coating Method]

The layers of the antireflection film can be formed by any method of dip coating, air knife coating, curtain coating, roller coating, wire bar coating, gravure coating, microgravure coating and extrusion coating (U.S. Pat. No. 2,681,294).

### [Anti-Glare Function]

The antireflection film may have the anti-glare function that scatters external light. The anti-glare function can be obtained by forming irregularities on the surface of the antireflection film. When the antireflection film has the anti-glare function, the haze of the antireflection film is preferably 3 to 30%, more preferably 5 to 20%, and most preferably 7 to 20%.

As a method for forming irregularities on the surface of antireflection film, any method can be employed, as long as it can maintain the surface geometry of the film. Such methods include: for example, a method in which fine particles are used in the low-refractive-index layer to form irregularities on the surface of the film (e.g. Japanese Patent Application Laid-Open No. 2000-271878); a method in which a small amount (0.1 to 50% by mass) of particles having a relatively large size (0.05 to 2 μm in particle size) are added to the layer under a low-refractive-index layer (high-refractive-index layer, intermediate-refractive-index layer or hard coat layer) to form a film having irregularities on the surface and a low-refractive-index layer is formed on the irregular surface while keeping the geometry (e.g. Japanese Patent Application Laid-Open Nos. 2000-281410, 2000-95893, 2001-100004, 2001-281407); a method in which irregularities are physically transferred on the surface of the outermost layer (stainproofing layer) having been provided (e.g. embossing described in Japanese Patent Application Laid-Open Nos. 63-278839, 11-183710, 2000-275401).

### [Applications]

The unstretched and stretched cellulose acylate films of the present invention are useful as optical films, particularly as polarizer protective film, optical compensation sheet (also referred to as retardation film) for liquid crystal display devices, optical compensation sheet for reflection-type liquid crystal displays, and substrate for silver halide photographic photosensitive materials.

### (1) Preparation of a Polarizing Plate

### (1-1) Stretching

Unstretched cellulose acylate films were stretched by 300% per minute at a glass transition temperature (Tg)+10° C. of the respective films. Stretched cellulose acylate film examples include: (1) stretching at a longitudinal stretching ratio of 300% and a transverse stretching ratio of 0% to obtain a film having an Re of 200 nm and a Rth of 100 nm; (2) stretching at a longitudinal stretching ratio of 50% and a transverse stretching ratio of 10% to obtain a film having an Re of 60 nm and a Rth of 220 nm; (3) stretching at a longitudinal stretching ratio of 50% and a transverse stretching ratio of 50% to obtain a film having an Re of 0 nm and a Rth of 450 mm, (4) stretching at a longitudinal stretching ratio of 50% and a transverse stretching ratio of 10% to obtain a film having an Re of 60 mu and a Rth of 220 nm; and (5) stretching at a longitudinal stretching ratio of 0% and a transverse stretching ratio of 150% to obtain a film having an Re of 150 nm and a Rth of 150 nm.

### (1-2) Saponification of Cellulose Acylate Film

Unstretched cellulose acylate films and stretched cellulose acylate films underwent saponification according to the below-described immersion-saponification method. The same results were obtained in the case where coat saponification was carried out.

### (i) Immersion-Saponification

A 15 N aqueous solution of NaOH was used as a saponifying solution. This solution was adjusted to a temperature of 60° C., and the cellulose acylate film was immersed therein for 2 minutes. Thereafter, the film was immersed in a 0.1 N aqueous solution of sulfuric acid for 30 seconds, and passed through a water-washing bath.

### (ii) Coating-Saponification

20 parts by mass of water was added to 80 parts by mass of isopropyl alcohol, and KOH was dissolved therein so that the resultant solution concentration became 1.5 N. This solution was adjusted to a temperature of 60° C. to use as a saponifying solution. This solution was coated on a 60° C. cellulose acylate film in an amount of 10 g/m², and saponification was conducted for one minute. Then, 50° C. warm water was sprayed thereover for 1 minute in an amount of 10 L/m² per minute to conduct washing.

### (1-3) Preparation of a Polarizing Layer

The film was stretched in a longitudinal direction by applying a difference in peripheral speed between two pairs of nip rolls according to Example 1 in Japanese Patent Application Laid-Open No. 2001-141926, whereby a 20 μm thick polarizing layer was prepared.

### (1-4) Lamination

The thus-obtained polarizing layer and the above-described saponification-treated unstretched and stretched cellulose acylate films were laminated so that a 45° angle was formed between the polarizing axis and the longitudinal direction of the cellulose acylate film, using a 3% PVA aqueous solution (PVA-117H; manufactured by K.K. Kuraray) as an adhesive. Excellent performance can be obtained if the thus-produced polarizing plate is attached on the 20-inch VA-type liquid crystal display device illustrated in FIGS. 2 to 9 of Japanese Patent Application Laid-Open No. 2000-154261, and visual observation is performed at a 32° angle, at which the projected parallel lines are most easily viewed.

### (2) Preparation of Optical Compensation Film and Liquid Crystal Display Device

### (i) Unstretched Film

A good optical compensatory film can be produced using the unstretched cellulose acylate film according to the present invention on the first transparent support of Example 1 in Japanese Patent Application Laid-Open No. 11-316378.

### (II) Stretched Cellulose Acylate Film

A good optical compensatory film can be prepared by using the stretched cellulose acylate film according to the present invention in place of the cellulose acylate film coated with the liquid crystal layer of Example 1 in Japanese Patent Application Laid-Open No. 11-316378. A good optical compensatory film can also be prepared by preparing an optical compensatory filter film (referred to as “optical compensatory film B”) having the stretched cellulose acylate film according to the present invention in place of the cellulose acylate film coated with the liquid crystal layer of Example 1 in Japanese Patent Application Laid-Open No. 7-333433.

### (3) Preparation of an Anti-Reflective Film

Good optical performance can be obtained by preparing an anti-reflective film with the stretched and unstretched cellulose acylate film of the present invention according to Example 47 of Hatsumei Kyokai Kokai Giho (Kogi Bango 2001-1745).

### (4) Preparation of a Liquid Crystal Display Element

The polarizing plate according to the present invention may be employed in the liquid crystal display device described in Example 1 of Japanese Patent Application Laid-Open No. 10-48420, the orientation film coated with polyvinyl alcohol and an optical anisotropic layer containing discotic liquid crystal molecules described in Example 1 of Japanese Patent Application Laid-Open No. 9-26572, the 20-inch VA-type liquid crystal display device described in FIGS. 2 to 9 of Japanese Patent Application Laid-Open No. 2000-154261, and the 20-inch OCB-type liquid crystal display device described in FIGS. 10 to 15 of Japanese Patent Application Laid-Open No. 2000-154261. If the anti-reflective film according to the present invention is stuck onto the uppermost layer of these liquid crystal display devices, it can be confirmed from visual evaluation that good visual performance is obtained.

### Examples

### Cellulose Acylate Resin

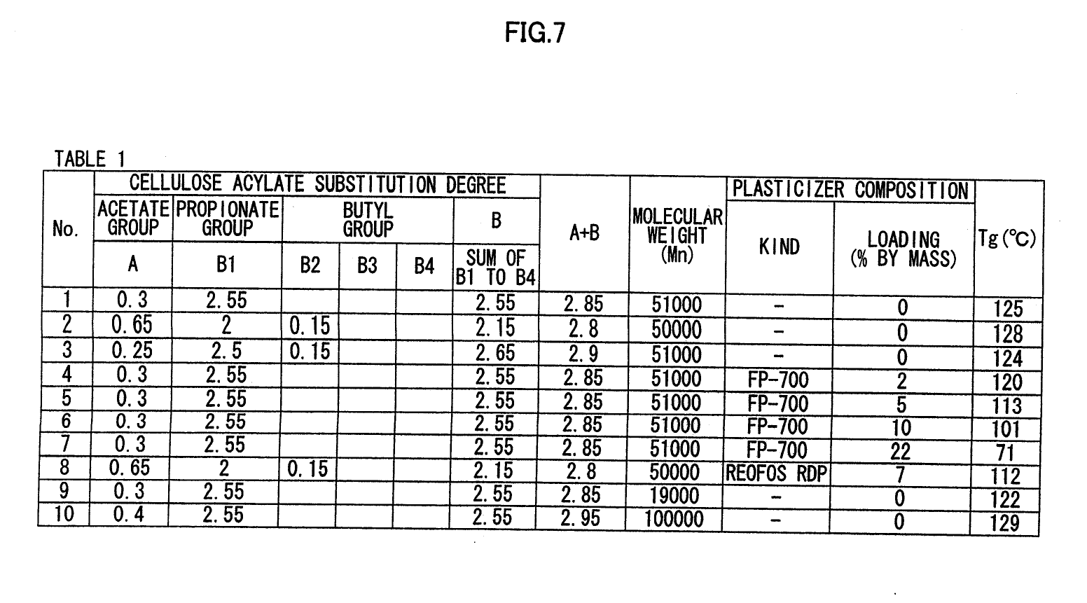

The cellulose acylates I to X having different kind and/or substitution degree of the acyl groups as listed in Table 1 of FIG. 7 were prepared. These were charged with sulfuric acid as a catalyst (7.8 parts by mass to 100 parts by mass of cellulose), and the resulting solutions were charged with a carboxylic acid, which serves as the raw material for the acyl substituent groups. An acylation reaction took place at 40° C. At this point, the kind and/or substitution degree of the acyl groups was controlled by the kind and/or amount of the carboxylic acid. After acylation, a ripening was performed at 40° C. In Table 1 of FIG. 7, FP-700 represents multimer consisting of bisphenol A and bis(phenyl phosphate), manufactured by Adeka Corporation and Reofos RDP represents resorcinol bis(diphenylphosphate) manufactured by Ajinomoto-Fine-Techno Co., Inc.

Melt Film forming

The synthesized cellulose acylates in Table 1 were blow-dried for 3 hours at 120° C. to reduce their moisture content to 0.1% by mass. Next, the plasticizers listed in Table 1 were charged into the cellulose acylates IV to VDT. A twin-screw kneading extruder was used to melt-knead at 190° C. This twin-screw kneading extruder was equipped with a vacuum vent to evacuate the vessel (to 0.3 atm.). The resultant material was extruded in 3 mm-diameter strands in a water bath. These strands were cut into 5 mm lengths.

The Tg of the thus-obtained cellulose acylates I to X was measured according to the following method, and the results are shown in Table 1. It is noted that the Tg for those cellulose acylates to which a plasticizer was added is shown as the value after the plasticizer had been added.

### Tg Measurement

A 20 mg sample was placed on the measuring pan of a DSC. The temperature of this sample was raised from 30° C. to 250° C. at 10° C. per minute in a nitrogen flow (first run), and then cooled to 30° C. at −10° C. per minute. The temperature was then again raised from 30° C. to 250° C. (second run). The glass transition temperature (Tg) was taken as the temperature at which the base line in the second run began to inflect from the low temperature side. All the levels were further charged with 0.05% by mass of silicon dioxide microparticles (Aerosil R972V).

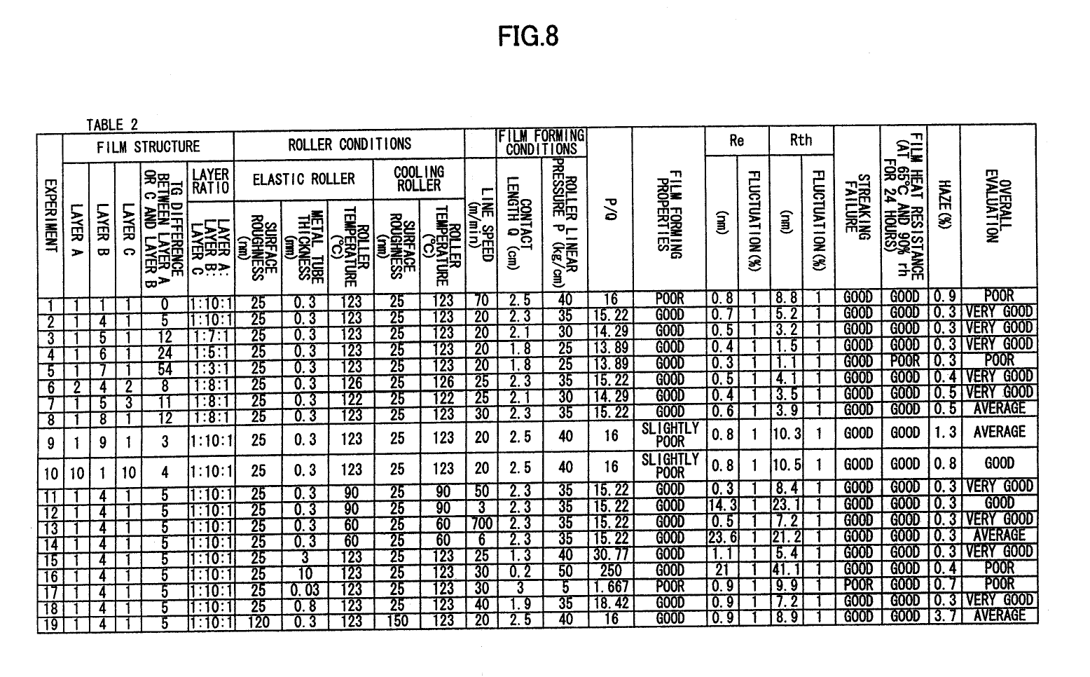

The above-described kneaded resins were dried for 3 hours with a 90° C. dehumidifying wind to reduce their moisture content to 0.1% by mass. The resins were then melted at 210° C. using a single-screw extruder having an L/D of 35 and a compression ratio of 33 and which was equipped with a full-flight screw having a 65 mm screw diameter. After melting, the resins were fed out at a constant amount using a gear pump to increase thickness accuracy. The melt polymer fed out from the gear pump was passed through a 4 μm sintering filter to remove contaminants. Cellulose acylate films were then formed by co-extrusion so as to have 3 cellulose acylate layers (layer A, layer B and layer C) having a film structure as shown in Table 2 of FIG. 8; a total thickness of 80 μm; and the layer ratio (layer A:layer B:layer C) of Table 2. The tri-layer sheets discharged through the die solidified by cooling using rollers 26, 28, and were thereby formed into a cellulose acylate film. The solidified sheets were peeled off the cooling roller 28, and then taken up in a roll shape. Here, the cooling roller 28 is a metal roller which has a diameter of 500 mm, thickness of 25 mm and a surface roughness Ra of 25 nm (except for Experiment 19, which has a surface roughness of 150 nm). The elastic roller 26 has a diameter of 300 mm and a surface roughness Ra of 25 nm. Further, just prior to the taking up, the sheets are trimmed on both sides (3% on each side over the entire width) and knurled on both sides with a width of 10 mm and a height of 50 μm. At each level, 3,000 m was taken up with a width of 13 m at 30 m/min.

The unstretched film thus obtained from each of the experiments then underwent retardation value (Re and Rth) measurement, streaking observation, and film heat resistance and haze measurement. An overall evaluation was also made from these results.

### (I) Retardation Values (Re and Rth)

Ten points were sampled at equidistant intervals in a width direction of the unstretched film. After subjecting the film to wetting for 4 hours at 25° C. and 60% rh, the in-plane retardation value (Re) and retardation value (Rth) in the film-thickness direction were calculated at 25° C. and 60% rh by measuring the phase difference value for a wavelength of 590 nm from a direction slanted in 10° increments from +50° to −50° from the film normal line with the perpendicular direction with respect to the sample film surface and the slow axis serving as the rotation axes using an automatic birefringence analyzer (“KOBRA-21ADH”, manufactured by Oji Scientific Instruments).

### (II) Observation of Streaking

The appearance of the obtained unstretched films was visually examined using four stages. Films which showed absolutely no streaking were evaluated as “good”, those in which tiny thin streaks could be seen, but could still be put to practical use, were evaluated as “average”, those in which thin streaks could be seen, but could not be put to practical use, were evaluated as “poor”, and those in which streaks could be seen at a glance were evaluated as “no good”.

### (III) Evaluation of Heat Resistance

The obtained sample films were wetted for at least 3 hours at 25° C. and 60% rh, then subjected to heat treatment for 24 hours at 60° C. and 90% rh, and then again wetted for at least 3 hours at 25° C. and 60% rh. The sample dimensions were measured using a pin gauge to determine the variation in dimensions before and after the heat treatment. Samples which had a lengthwise and widthwise dimension variation ratio of 0.3% or less were evaluated as “good”, and those which had either or both a lengthwise or a widthwise dimension variation ratio of more than 0.3% were evaluated as “poor”.

### (IV) Haze Measurement

The obtained unstretched films were measured using a turbidimeter NDH-1001 DP (manufactured by Nippon Denshoku Industries Co., Ltd.).

### (V) Overall Evaluation

Based on results of the above-described evaluations, overall evaluation was carried out using the following four stages.

Very good: A film having very good film optical properties and mechanical strength.
Good: A film having good film optical properties and mechanical strength.
Average: A film having slight problems with film optical properties or mechanical strength, but which can still be used depending on the product.
Poor: A film having problems with film optical properties and mechanical strength, which cannot be used for a product.

As can be seen from Table 2 of FIG. 8, among Experiments 1 to 19, Experiments 16 and 17 had a thickness of the metal tube (outer tube thickness) constituting the outer shell of the elastic roller out of the range of 0.05 to 0.7 mm; and Experiments 1 and 5 did not have, from among the three layers (layer A, layer B and layer C), a glass transition temperature Tg of the inner layer (B layer) resin in a range of 3 to 50° C. less than the Tg of the outer layers (layers A and C). Therefore, these experiments were given a “poor” overall evaluation, as compared with those experiments which did satisfy the conditions according to the present invention, which comprise a metal tube thickness Z constituting the outer shell of the elastic roller in the range of 0.05<Z<7.0 mm, and, in a laminate sheet, a glass transition temperature Tg of the thermoplastic resin forming the inner layer 3 to 50° C. less than the glass transition temperature Tg of the thermoplastic resin forming an outer layer.

Further, among the experiments which satisfied the above-described conditions and were evaluated as acceptable (average to very good), Experiments 8, 12 and 14, in which the line speed (Y) did not satisfy the equation 0.0043X²+0.12X+1.1<Y<0.019X²+0.73X+24 when the elastic roller temperature was subtracted from the Tg of the outer layers (layers A and C), were evaluated as being average to good as compared with the other experiments. In addition, Experiment 19, which did not satisfy the condition that arithmetic average roughness Ra of the roller surface of at least one of the pair of rollers is no greater than 100 nm, was given an overall evaluation of “average” as compared with the other experiments.

### Preparation of a Polarizing Plate

### 1. Preparation of a Polarizing Plate

Unstretched films according to the present invention underwent saponification according to the below-described dipping method. Coat saponification was also carried out, but the results were the same as those for immersion-saponification.

### (i) Immersion-Saponification

A 1.5 N aqueous solution of NaOH was used as a saponifying solution.

This solution was adjusted to a temperature of 60° C., and a thermoplastic resin film was immersed therein for 2 minutes.

Thereafter, the film was immersed in a 0.1 N aqueous solution of sulfuric acid for 30 seconds, and passed through a water-washing bath.

### (ii) Coat Saponification

20 parts by mass of water was added to 80 parts by mass of isopropyl alcohol, and KOH was dissolved therein so that the resultant solution concentration became 1.5 N. This solution was adjusted to a temperature of 60° C. to use as a saponifying solution.

This solution was coated on a 60° C. cellulose acylate film in an amount of 10 g/m², and saponification was conducted for one minute.

Then, 50° C. warm water was sprayed thereover for 1 minute in an amount of 10 L/m² per minute to conduct washing.

### (2) Preparation of a Polarizing Layer

The film was stretched in a longitudinal direction by applying a difference in peripheral speed between two pairs of nip rolls according to Example 1 in Japanese Patent Application Laid-Open No. 2001-141926, whereby a 20 μm thick polarizing layer was prepared. A polarizing plate was also prepared as described in Example 1 of Japanese Patent Application Laid-Open No. 2002-86554, by stretching so that the stretching axis had a slant of 45°. However, the evaluated results were the same for this as for the above-described method.

### (3) Lamination

The thus-obtained polarizing layer and the above-described saponification-treated and stretched thermoplastic resin films prepared by the above-described methods were used to prepare a laminate polarizing plate using a 3% PVA aqueous solution (PVA-117H; manufactured by K.K. Kuraray) as an adhesive. The below-described FUJI TAC (TD80 manufactured by Fuji Photo Film Co., Ltd.) was also subjected to the above-described saponification-treatment.

Polarizing plate A: unstretched film/polarizing layer/FUJI TAC
Polarizing plate B: unstretched film/polarizing layer/unstretched film
(the same thermoplastic resins were employed for the unstretched films of Polarizing plate B)

A fresh polarizing plate obtained in the above-described trimmer and a polarizing plate which had been subjected to a wet thermotreatment (60° C., 90% rh, 500 hours) and a dry thermotreatment (80° C., 500 hours) were employed in the 20-inch VA-type liquid crystal display device described in FIGS. 2 to 9 of Japanese Patent Application Laid-Open No. 2000-154261 so that the stretched cellulose acylate film was on the liquid crystals side. A comparison between the device employing the fresh polarizing plate and the device employing the aged polarizing plate by visual observation showed that the devices prepared in accordance with the present invention achieved good performance in terms of the ratio of the regions exhibiting color irregularities as a percentage of the total surface area.

### 2. Optical Compensatory Film Preparation

The stretched thermoplastic resin film according to the present invention was used in place of the cellulose acylate film coated with the liquid crystal layer of Example 1 in Japanese Patent Application Laid-Open No. 11-316378. In this case, a visual comparison between a device employing a film immediately after being stretched (fresh product) and a film which had been subjected to a wet thermotreatment (60° C., 90% rh, 500 hours) and a dry thermotreatment (80° C., 500 hours) of the regions exhibiting color irregularities showed that the present invention could prepare good optical compensatory films.

A good optical compensatory film can also be prepared with films prepared using an optical compensatory filter film having the stretched thermoplastic resin film according to the present invention in place of the cellulose acylate film coated with the liquid crystal layer of Example 1 in Japanese Patent Application Laid-Open No. 7-333433.

### 3. Preparation of an Anti-Reflective Film

Good optical performance can be obtained by preparing an anti-reflective film with the stretched thermoplastic resin film of the present invention according to Example 47 of Hatsumei Kyokai Kokai Giho (Kogi Bango 2001-1745).

### (4) Preparation of a Liquid Crystal Display Device

Further, the polarizing plate according to the above-described present invention may be employed in the liquid crystal display device described in Example 1 of Japanese Patent Application Laid-Open No. 1048420, the orientation film coated with polyvinyl alcohol and an optical anisotropic layer containing discotic liquid crystal molecules described in Example 1 of Japanese Patent Application Laid-Open No. 9-26572, the 20-inch VA-type liquid crystal display device described in FIGS. 2 to 9 of Japanese Patent Application Laid-Open No. 2000-154261, the 20-inch OCB-type liquid crystal display device described in FIGS. 10 to 15 of Japanese Patent Application Laid-Open No. 2000-154261, and the IPS-type liquid crystal display device described in FIG. 11 of Japanese Patent Application Laid-Open No. 2004-12731. When the anti-reflective film according to the present invention was stuck onto the uppermost layer of these liquid crystal display devices, evaluation showed that a good liquid crystal display device was obtained.

1. A method for producing a thermoplastic resin film including the steps of:
forming a film by extruding melted thermoplastic resins in sheet form through a die; and
cooling and solidifying the sheet into the film by sandwiching the sheet between a pair of rollers configured so that at least one of the rollers is an elastic roller made from metal, the thickness Z of a metal tube constituting an outer shell of the elastic roller being in a range of 0.05 mm<z<7.0 mm, wherein
the sheet is formed as a laminate sheet having two or more layers by using two or more of the thermoplastic resins, and in the laminate sheet a glass transition temperature Tg (° C.) of the thermoplastic resin forming an inner layer is 3 to 50° C. less than the glass transition temperature Tg (° C.) of the thermoplastic resin forming an outer layer.

2. The method for producing a thermoplastic resin film according to claim 1, wherein
the pair of rollers satisfies both the following equations (1) and (2):
when the glass transition temperature Tg (° C.) of the thermoplastic resin forming the outer layer minus the temperature (° C.) of the elastic roller is represented as “X” (° C.), and the line speed is represented as “Y” (m/min),
0.0043X²+1.2X+1.1<Y<0.019X²+0.73X+24 (1)
and when the length along which the pair of rollers are in contact with each other via the laminate sheet is represented as “Q” (cm), and the linear pressure sandwiching the laminate sheet by the pair of rollers is represented as “P” (kg/cm).
3 kg/cm²<P/Q<50 kg/cm² (2).

3. The method for producing a thermoplastic resin film according to claim 1, wherein
at least one roller of the pair of rollers has a surface having an arithmetic average roughness Ra of no greater than 100 nm.

4. The method for producing a thermoplastic resin film according to claim 1, wherein
the laminate sheet is formed by co-extrusion.

5. The method for producing a thermoplastic resin film according to claim 1, wherein
the laminate sheet has an A/B/A tri-layer structure consisting of a thermoplastic resin A forming the outer layers and a thermoplastic resin B forming the inner layer, and a glass transition temperature Tg (° C.) of the thermoplastic resin B is 3 to 50° C. less than a glass transition temperature Tg (° C.) of the thermoplastic resin A.

6. The method for producing a thermoplastic resin film according to claim 1, wherein
the laminate sheet has an A/B/C/B/A five-layer structure consisting of a thermoplastic resin layer A forming the outer layers and thermoplastic resins B and C forming the inner layers, and glass transition temperatures Tg (° C.) of the thermoplastic resins B and C are 3 to 50° C. less than a glass transition temperature Tg (° C.) of the thermoplastic resin A.

7. The method for producing a thermoplastic resin film according to claim 1, wherein
the laminate sheet has an A/B bi-layer structure consisting of a thermoplastic resin A forming the outer layer and a thermoplastic resin B forming the inner layer, and when one of the pair of rollers is an elastic resin, the thermoplastic resin A in contact with the elastic roller serves as the outer layer.

8. The method for producing a thermoplastic resin film according to claim 1, wherein
the thermoplastic resins, when discharged through the die, have a zero shear viscosity no greater than 2,000 Pa·sec.

9. The method for producing a thermoplastic resin film according to claim 1, wherein
the thickness of the thermoplastic resin forming the outer layer is in a range of 10 to 90% of the film total thickness.

10. The method for producing a thermoplastic resin film according to claim 1, wherein
the width of the thermoplastic resin forming the outer layer is 99% or more of the film total width.

11. The method for producing a thermoplastic resin film according to claim 1, wherein
the film has a thickness of 20 to 300 μm, an in-plane retardation Re no greater than 20 nm and a thickness direction retardation Rth no greater than 20 nm.

12. The method for producing a thermoplastic resin film according to claim 1, wherein
the thermoplastic resin is a cellulose acylate resin.

13. The method for producing a thermoplastic resin film according to claim 12, wherein
the cellulose acylate resin has an average molecular weight of 20,000 to 80,000, and when “A” represents the degree of substitution of an acyl group and “B” represents the sum of the degree of substitution of an acyl group having 3 to 7 carbon atoms, satisfies 2.05≦A+B≦3.0, 0≦A≦2.0 and 1.2≦B<2.9.

14. A thermoplastic resin film produced by the production process according to claim 1.

15. An optical compensatory film for a liquid crystal display plate comprising the thermoplastic resin film according to claim 14 as a substrate.

16. A polarizing plate formed using at least one ply of the thermoplastic resin film according to claim 14 as a protective film of a polarizing film.
